(19) United States
(12) Patent Application Publication
(10) Pub. No.: US 2008/0006290 A1
(43) Pub. Date: Jan. 10, 2008

(54) Fluidized bed apparatus and filter washing method for fluidized bed apparatus

(76) Inventors: Kuniaki Yamanaka, Shinjuku-ku (JP); Shigemi Isobe, Shinjuku-ku (JP); Kazuomi Unosawa, Shinjuku-ku (JP); Narimichi Takei, Shinjuku-ku (JP); Yuriko Hirai, Shinjuku-ku (JP); Takashi Terada, Shinjuku-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/822,529

(22) Filed: Jul. 6, 2007

(30) Foreign Application Priority Data
Jul. 10, 2006 (JP) 2006-189529
Apr. 13, 2007 (JP) 2007-106461

(51) Int. Cl. B08B 3/04; B01J 8/08; B08B 3/12; B08B 9/04

(52) U.S. Cl. 134/1; 134/137; 134/138; 134/32; 134/33; 134/37; 134/42; 422/139; 422/143

(57) ABSTRACT

A cartridge filter 7 is vertically movably placed in a processing vessel 1 having a cylindrical profile. An ultrasonic washer 55 is fitted to the lateral wall 3a of the spray casing of the processing vessel 1. Washing liquid 56 is injected into the processing vessel 1 and the filter 7 is moved downward and immersed in the washing liquid 56. The washer 55 is activated under this condition to wash the filter 7. Since the washer 55 is arranged near the filter 7, the ultrasonic oscillation is easily transmitted to the filter 7 to efficiently remove the foreign objects adhering to the filter 7. Thus, with this arrangement, it is possible to wash the filter 7 in the processing vessel 1 without removing the filter 7 from a fluidized bed apparatus. In a filter washing apparatus 101, a cartridge filter 103 is contained in a processing vessel 102 and immersed in washing liquid 110. The filter 103 is rotatably suspended below an upper lid 104 by means of a retainer 107a, 107b, a rotary joint 108 and a filter anchoring knob 111. Then, it is washed in the washing liquid 110 as it is driven to rotate by a jet flow 144.

### BACKGROUND OF THE INVENTION

1. Field of the Invention

The present invention relates to a fluidized bed apparatus to be used for granulation and coating of powder and particle. More particularly, the present invention relates to a fluidized bed apparatus in which the filter arranged therein for separating particulates can be washed efficiently in the apparatus. Additionally, the present invention relates to a technique of washing a filter mounted in a particulate processing apparatus. More particularly, it relates to a process for washing a cartridge filter having a pleats-like structure.

2. Related Art Statement

Various products are manufactured by processing fine materials such as particulate materials by way of granulation, coating, mixing, drying and so on in the field of medicines, cosmetics and foods etc. For such a processing, fluidized bed granulation, coating apparatus and other particulate processing apparatus are being widely used for the purpose of fluidizing fine materials by means of a gas flow and granulating, coating, mixing, agitating and drying them. In a fluidized bed apparatus, binding liquid, coating liquid and so on are supplied to a fluidized particulate material by means of a spray nozzle to carry out processes such as granulation and coating. FIG. 23 of the accompanying drawings schematically illustrates such a fluidized bed apparatus. Referring to FIG. 23, the fluidized bed apparatus 201 comprises a cylindrical processing vessel 202 and the object of processing such as a particulate material is fed into the inside thereof and subjected to processes such as granulation and coating.

An air-permeable perforated plate 203 that is typically formed by using a wire mesh is arranged under the vessel 202. Processing gas is supplied from below the perforated plate 203 and the object of processing is fluidized in the vessel 202 by the processing gas. A spray nozzle 204 is arranged substantially at the center of the vessel 202 for the purpose of atomizing binding liquid, coating liquid and so on. A ceiling plate 205 is arranged at an upper part of the vessel 202. Gas is supplied to the fluidized bed apparatus in order to fluidize the particulate material. On the other hand, the fluidized bed apparatus is equipped with filter for separating the particulate material from the gas to be drawn off. The filters 206 are fitted to the ceiling plate 205. The particulate material that is fluidized by the gas flow is filtered and sorted so that only gas is isolated and driven off to the outside of the fluidized bed apparatus. The filters 206 sort out the particulate material from the gas flow and prevent powder including fine powder and pulverulent bodies from leaking to the outside of the processing system.

Cartridge type filters comprising a filter element typically made of unwoven fabric of polyester or polyamide are typically used for the filters 206. Jet nozzles 207 for backwashing the filter are arranged above the respective filters 206. A cartridge filter made of filter fabric and shaped to show pleats is often employed in order to provide an increased filtering area.

When the filtering material is clogged in such a filter, the gas flow is blocked to obstruct the operation of fluidizing the particulate material and reduce the process efficiency. Therefore, the powder adhering to the filters 206 is blown off from the filters 206 by means of pulse jets from the nozzles 207 from time to time during the ongoing process in order to prevent the filtering material from being clogged. The operation of scraping off fine powder is also referred to “a backwashing”, for which pulsated air is supplied in the direction opposite to the direction of the fluidized gas flow. For example, when a fluidizing gas flow is directed from the outside to the inside of the filters, a pulse jet nozzle is arranged in the inside of each of the filters and pulsated air is blown out from the inside toward the outside of the filters. Then, as a result, the fine particles of the particulate material adhering to the powder capturing surfaces (outside surfaces) of the filters is blown off to maintain the filter to function properly.

However, it is not possible to completely blow off the adhering powder by means of a backwashing process and powder gradually accumulates to increase the resistance against the air flow. Thus, in a granulation process, the filters 206 need to be temporarily removed from the apparatus 201 and washed when the processing time exceeds a predetermined time period. Particularly, in the case of pleated filters, the fine powder adhering to the bottoms of the pleats is apt to agglomerate and backwashing air can hardly get to the bottoms of the pleats so that it is difficult to satisfactorily remove the fine powder adhering to the bottoms of the pleats. More particularly, in the case of pleated filters having large folded parts, it is highly difficult to remove the fine powder adhering to the bottoms of the pleats. When the number of pleats per filter is large, it is difficult to thoroughly wash the bottom areas of each pleat by means of a washing nozzle.

Additionally, the filters 206 need to be washed when the same apparatus is operated to process particulates of different types or different binding or coating liquids are sprayed. While the filters 206 are removed from the fluidized bed apparatus 201 and washed manually in general, various automatic washing apparatus have been proposed because the manual washing operation requires human resources and time.

For example, Jpn. U.M. Appln. Laid-Open Publication No. 60-176240 describes an apparatus for lowering a filter in a fluidized bed apparatus and washing the filter by means of a lower fixed washing nozzle that is standing by and a vertically movable upper washing nozzle. Jpn. Pat. Appln. Laid-Open Publication No. 8-309130 describes a so-called pooling/washing type bag filter washing method. According to the cited Patent Document, a filtering cylinder and a fluidizing cylinder are separated from each other by means of a partition plate and a filtering chamber is put into a water-tight condition and operated as washing chamber. After injecting detergent into the filtering chamber, the filter is subjected to mechanical vertical vibrations (shaking operation) to wash the filter easily and reliably within a short period of time.

Jpn. Pat. Appln. Laid-Open Publication No. 6-262015 describes wet washing method for a filter cartridge that drives a filter to rotate for washing in addition to ultrasonic washing. With the disclosed washing method, a cartridge filter having pleats is arranged so that it can freely rotate and washing liquid is sprayed toward the outer periphery thereof from an oblique direction. Then, as a result, the filter is driven to rotate by washing liquid so that washing liquid is sprayed onto the entire surface of the filter efficiently in concentrated manner.

On the other hand, PCT Publication No. 2005-530601 describes a fluidized bed processing apparatus comprising a group of movable filters that can be selectively moved in a fluidized bed chamber. The filters for filtering process air are arranged so as to be vertically movable between a first position for filtering air and a second position for inspections and repairing operations. The apparatus is provided with a cleaning mechanism for backwashing processes and fine powder is removed by the cleaning mechanism. The filters can be removed at the second position for cleaning and replacement.

Jpn. Pat. Appln. Laid-Open Publication No. 2003-200014 relates to a filter to be used in the exhaust gas line of an automobile. It describes a washing method of immersing and washing a micro particle filter in a washing solution. The filter is separated from the exhaust gas line and decomposed. Subsequently, it is immersed and washed in a tank containing a washing solution to remove the mineral residue that clogs the filter.

However, a pooling/washing system as described in Jpn. Pat. Appln. Laid-Open Publication No. 8-309130 does not provide a satisfactory washing effect for washing the filters being used in fluidized bed apparatus and, in the long run, the filters need to be removed and washed separately outside the apparatus. The rotary washing system as described in Jpn. Pat. Appln. Laid-Open Publication No. 6-262015 can only roughly wash filters. In other words, it is not a self-completing type washing system and requires a filter-washing process to be conducted outside the apparatus. Thus, known fluidized bed apparatus require time and labor for washing the filters and such washing processes give rise to a problem of baffling efforts to improve the productivity of the apparatus. Additionally, washing systems that entail a process outside the apparatus can expose (and scatter) the detergent and the residual fine powder to the outside of the apparatus to contaminate the surrounding of the apparatus. Such a problem is particularly disadvantageous from the viewpoint of containment in drug manufacturing facilities.

In an attempt to cope with the above-identified problems, there have been proposed systems of arranging an ultrasonic washer or a bubbling washer in a fluidized bed apparatus to wash the filters and the inside of the fluidized bed apparatus simultaneously while the inside of the apparatus is filled with washing water. However, when an ultrasonic washer or a bubbling washer is arranged at the bottom section of a fluidized bed apparatus for such a system, there arises a problem that the filters arranged in an upper part of the fluidized bed apparatus cannot be washed satisfactorily because of the coverage of ultrasonic waves or bubbles. This problem is particularly remarkable in large apparatus so that a washing system using an ultrasonic washer or a bubbling washer is not feasible for large apparatus.

### SUMMARY OF THE INVENTION

Therefore, it is an object of the present invention to provide a fluidized bed apparatus comprising filters arranged therein that can be washed with ease within the apparatus without being removed from the latter and also a filter washing method to be used for fluidized bed apparatus. Another object of the present invention is to provide a filter washing apparatus and a filter washing method that can efficiently wash cartridge filters being used in fluidized bed granulation apparatus.

In an aspect of the present invention, there is provided a fluidized bed apparatus comprising: a processing vessel having a cylindrical profile; a filter member arranged in the processing vessel so as to be immersed in washing liquid to be injected and retained in the processing vessel; and a washer fitted to the lateral wall of the processing vessel so as to be capable of washing the filter member immersed in the washing liquid.

Thus, according to the present invention, a filter member is immersed in the washing liquid that fills the inside of the processing vessel and subjected to a washing process by means of the washer fitted to the lateral wall of processing vessel. In the fluidized bed apparatus, the filter member is washed by means of the washer arranged near the filter in a washing process so that the filter member can be washed efficiently in the apparatus. Accordingly, the filter member can be washed without being taken out from the apparatus so that the number of man-hour of the washing process is reduced. Additionally, since the filter member is washed within the apparatus, the operator is or operators are not required to touch the solution of chemical agent during the washing process to improve the environment of operation.

In a fluidized bed apparatus as defined above, an ultrasonic washer for applying an ultrasonic oscillation to the washing liquid may be used for the washer. It is also possible to use a bubbling washer for supplying a bubble flow or liquid containing bubbles to the washing liquid for the washer. If such is the case, the filter member may be rotatably arranged in the processing vessel so as to be driven to rotate in the washing liquid by a bubble flow or liquid containing bubbles. Furthermore, the filter member may be vertically movably arranged in the processing vessel.

Additionally, in a fluidized bed apparatus as defined above, the processing vessel may include a filter casing in which the filter is arranged, a spray casing in which a spray nozzle for spraying liquid to an object of processing is arranged, a material container containing the object of processing and a gas feed unit for feeding processing gas to the material container and the washer may be arranged at the lateral wall of the spray casing.

A fluidized bed apparatus as defined above may further comprise a perforated plate arranged in the processing vessel so as to be displaceable between a first position where it is disposed substantially horizontally and a second position where it is inclined by a predetermined angle relative to the first position. When a washing process is executed while the perforated plate is held in an inclined state, it is possible to remove the deposit of substances insoluble to washing liquid on the perforated plate. Thus, it is possible to prevent substances insoluble to washing liquid from depositing on the perforated plate.

In another aspect of the present invention, there is provided a filter washing method in a fluidized bed apparatus including a processing vessel having a cylindrical profile and a filter member arranged in the processing vessel, said method comprising: injecting washing liquid into the processing vessel; immersing the filter member in the washing liquid retained in the processing vessel; and washing the filter member immersed in the washing liquid by means of a washer fitted to the lateral wall of the processing vessel.

Thus, according to the present invention, a filter member is immersed in the washing liquid that fills the inside of the processing vessel and subjected to a washing process by means of the washer fitted to the lateral wall of processing vessel. In a washing process using a filter washing method according to the present invention, the filter member is washed by means of the washer arranged near the filter in a washing process so that the filter member can be washed efficiently in the apparatus. Accordingly, the filter member can be washed without being taken out from the apparatus so that the number of man-hour of the washing process is reduced. Additionally, since the filter member is washed within the apparatus, the operator is or operators are not required to touch the solution of chemical agent during the washing process to improve the environment of operation.

In a filter washing method as defined above, an ultrasonic oscillation may be applied to washing liquid from the washer to wash the filter member. Alternatively, a bubble flow may be supplied to the washing liquid from the washer to wash the filter member. With such an arrangement, the filter may be driven to rotate in the washing liquid by the bubble flow. Furthermore, the filter member may be arranged so as to be vertically movable in the processing vessel and moved to a downward position in the processing vessel while washing liquid is injected into and retained in the processing vessel so as to be immersed in the washing liquid.

Additionally, in a filter washing method as defined above, a perforated plate may be arranged in the processing vessel so as to be displaceable between a first position where it is disposed substantially horizontally and a second position where it is inclined by a predetermined angle relative to the first position and the filter member is washed when the perforated plate is displaced to the second position.

In still another aspect of the present invention, there is provided a filter washing apparatus comprising: a processing vessel formed so as to be able to retain washing liquid and rotatably contain a filter to be used in a particulate processing apparatus in a state where washing liquid is injected and retained; and a nozzle device fitted to the processing vessel and adapted to inject a bubble flow or liquid containing bubbles to the filter immersed in the washing liquid in order to drive the filter to rotate in the washing liquid and wash the filter.

Thus, in a filter washing apparatus as defined above, a filter is immersed in the processing vessel that stores washing liquid and a washing process is executed by means of a bubble flow or liquid containing bubbles that is injected from the nozzle device fitted to the processing vessel so as to drive the filter to rotate and wash the latter. Thus, in the filter washing apparatus, it is possible to wash the entire periphery of the filter by means of a single nozzle device in a washing process as the filter is driven to rotate. Additionally, as the filter is driven to rotate, the centrifugal force produced by the rotary motion of the filter expels the fine powder accumulated in the bottom of the filter to the outside of the filter with washing liquid to execute the washing process highly efficiently.

In still another aspect of the present invention, there is provided a filter washing apparatus comprising: a processing vessel formed so as to be able to retain washing liquid and rotatably contain a filter to be used in a particulate processing apparatus in a state where washing liquid is injected and retained; and a nozzle device fitted to the processing vessel and adapted to inject a liquid flow to the filter immersed in the washing liquid in order to drive the filter to rotate in the washing liquid and wash the filter.

Thus, in a filter washing apparatus as defined above, a filter is immersed in the processing vessel that stores washing liquid and a washing process is executed by means of a liquid flow that is injected from the nozzle device fitted to the processing vessel so as to drive the filter to rotate and wash the latter. Thus, in the filter washing apparatus, as the filter is driven to rotate in a washing process, the centrifugal force produced by the rotary motion of the filter expels the fine powder accumulated in the bottom of the filter to the outside of the filter with washing liquid to execute the washing process highly efficiently.

In a filter washing apparatus as defined above, the processing vessel may be further provided with an ultrasonic washer for applying an ultrasonic oscillation to the filter immersed in the washing liquid and washing the filter in the washing liquid. With such an arrangement, the filter is driven to rotate by the nozzle device and, at the same time, the washing liquid is oscillated by the high frequency ultrasonic wave emitted from the ultrasonic washer. Thus, the filter is washed in the washing liquid by cavitations and micro-oscillation of the washing liquid in addition to rotary washing.

The processing vessel may further include: a first retainer inserted into and rigidly anchored to the filter; a second retainer connected to the first retainer by way of a rotary joint to make the first retainer rotatable and rotatably suspending the filter in the processing vessel; and a support roller unit fitted to the first retainer so as to be arranged in the inside of the filter and equipped with rollers adapted to contact the inner peripheral surface of the filter. With this arrangement, the filter is supported by the support roller unit from the side of the inner periphery thereof so that the filter can revolve in a stabilized manner.

The processing vessel may further include: a column arranged on the bottom section of the processing vessel; a filter guide rotatably mounted to the column and adapted to be inserted into the filter; and guide pieces arranged on the outer peripheral section of the filter guide so as to contact the inner peripheral surface of the filter when inserted into the filter with the filter guide. With this arrangement, the filter is supported from the inner peripheral side thereof by the filter guide and the guide pieces so that the filter can revolve in a stabilized manner.

In still another aspect of the present invention, there is provided a filter washing method of washing a filter to be used in a particulate processing apparatus by containing the filter in a processing vessel storing washing liquid, said method comprising: rotatably arranging the filter in processing vessel; and injecting a bubble flow or liquid containing bubbles from a nozzle device arranged in the processing vessel to the filter along a tangential direction and washing the filter, driving the filter to rotate by means of the bubble flow or the liquid containing bubbles.

Thus, according to the present invention, a filter is immersed in a processing vessel storing washing liquid and a washing process is executed while driving the filter to rotate by means of the bubble flow or the liquid containing bubbles that is injected from the nozzle device fitted to the processing vessel. In the filter washing apparatus, it is possible to wash the entire periphery of the filter by means of a single nozzle device in a washing process as the filter is driven to rotate. Additionally, as the filter is driven to rotate, the centrifugal force produced by the rotary motion of the filter expels the fine powder accumulated in the bottom of the filter to the outside of the filter with washing liquid to execute the washing process highly efficiently.

In a further aspect of the present invention, there is provided a filter washing method of washing a filter to be used in a particulate processing apparatus by containing the filter in a processing vessel storing washing liquid, said method comprising: rotatably arranging the filter in processing vessel; and injecting a washing liquid from a nozzle device arranged in the processing vessel to the filter along a tangential direction and washing the filter, driving the filter to rotate by means of the washing liquid.

Thus, according to the present invention, a filter is immersed in a processing vessel storing washing liquid and a washing process is executed while driving the filter to rotate by means of the washing liquid that is injected from the nozzle device fitted to the processing vessel. In the filter washing apparatus, it is possible to wash the entire periphery of the filter by means of a single nozzle device in a washing process as the filter is driven to rotate. Additionally, as the filter is driven to rotate, the centrifugal force produced by the rotary motion of the filter expels the fine powder accumulated in the bottom of the filter to the outside of the filter with washing liquid to execute the washing process highly efficiently.

An ultrasonic oscillation may be applied to the filter immersed in the washing liquid to wash the filter by means of the ultrasonic wave. With such an arrangement, the filter is driven to rotate by a bubble flow from the nozzle device etc. and, at the same time, the washing liquid is oscillated by the high frequency ultrasonic wave emitted from the ultrasonic washer. Thus, the filter is washed in the washing liquid by cavitations and micro-oscillation of the washing liquid in addition to rotary washing.

### BRIEF DESCRIPTION OF THE DRAWINGS

FIG. 1 is a schematic illustration of Embodiment 1 of the present invention, which is a fluidized bed apparatus, showing the configuration thereof;

FIG. 2 is a schematic perspective view of the material container of the fluidized bed apparatus of FIG. 1 as viewed from the screen unit side (lower side) thereof;

FIG. 3 is a schematic illustration of the screen unit of the fluidized bed apparatus of FIG. 1, showing the configuration thereof;

FIGS. 4A through 4F are schematic illustrations of the fluidized bed apparatus of FIG. 1 in different washing steps;

FIG. 5 is a schematic illustration of Embodiment 2 of the present invention, which is a fluidized bed apparatus, showing the configuration thereof;

FIG. 6 is a schematic illustration of the fluidized bed apparatus of FIG. 5, showing the filter washing process thereof;

FIG. 7 is a schematic illustration of Embodiment 3, which is filter washing apparatus, showing the configuration thereof;

FIG. 8 is a schematic illustration of the filter washing apparatus of FIG. 7 as viewed from the right side in FIG. 7;

FIG. 9 is a schematic illustration of the filter washing apparatus of FIG. 7 as viewed from above in FIG. 7;

FIG. 10 is a schematic illustration of one of the support roller units of the filter washing apparatus of FIG. 7;

FIG. 11 is a schematic illustration of the jet injection of the bubbling jet nozzles of the filter washing apparatus of FIG. 7;

FIG. 12 is a schematic illustration of the bubbling jet nozzles of the filter washing apparatus of FIG. 7 when they are arranged at the wall surface of the processing vessel;

FIG. 13 is a schematic illustration of the liquid flow generation nozzles of the filter washing apparatus of FIG. 7 arranged at the wall surface of the processing vessel to replace the bubbling jet nozzles;

FIG. 14 is a schematic illustration of Embodiment 4, which is a filter washing apparatus, showing the configuration thereof;

FIG. 15 is a schematic illustration of a filter washing apparatus of FIG. 14 as modified by arranging an ultrasonic washer on the bottom plate of the filter washing apparatus;

FIG. 16 is a schematic illustration of Embodiment 5, which is a filter washing apparatus, showing the configuration thereof;

FIG. 17 is a schematic illustration of Embodiment 6, which is a filter washing apparatus, showing the configuration thereof;

FIG. 18 is a schematic illustration of one of the support roller units of the filter washing apparatus of FIG. 17;

FIG. 19 is a schematic illustration of Embodiment 7, which is a filter washing apparatus, showing the configuration thereof;

FIG. 20 is a schematic illustration of the filter washing apparatus of FIG. 19 as viewed from above;

FIGS. 21A, 21B, 21C are schematic illustrations of one of the filters of the filter washing apparatus of FIG. 19, showing how the filter is set in position;

FIG. 22 is a schematic illustration of a filter washing apparatus obtained by modifying the apparatus of FIG. 19; and

FIG. 23 is a schematic illustration of a known fluidized bed apparatus, showing the coefficient thereof.

### DESCRIPTION OF THE PREFERRED EMBODIMENT

Now, the present invention will be described in greater detail by referring to the accompanying drawings that illustrate preferred embodiments of the invention.

### Embodiment 1

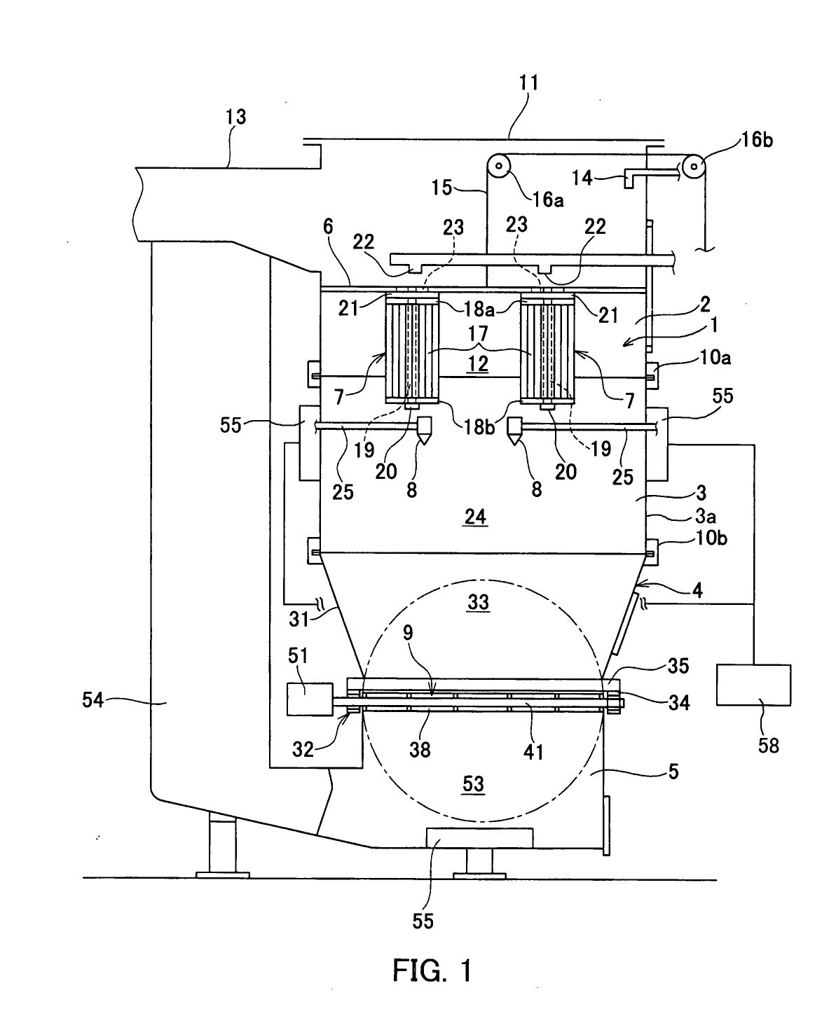

FIG. 1 is a schematic illustration of Embodiment 1 of the present invention, which is a fluidized bed apparatus. The fluidized bed apparatus of FIG. 1 comprises a processing vessel 1 having a cylindrical profile and is adapted to carry out a coating process on the surface of a particulate material. The processing vessel 1 is formed by sequentially arranging a filter casing 2, a sprayer casing 3, a material container 4 and a unit 5 from above, which are laid one on the other.

The casing 2, the casing 3 and the container 4 are connected to each other by means of cramps 10a, 10b. Adjacent ones of the casings and the container are air-tightly linked to each other typically by means of a sealing member. Alternatively, the upper one of the casings may be pushed from under and adjacent ones of the casings and the container may be air-tightly linked to each other by means of a sealing member. A ceiling plate 6 is arranged in the filter casing 2. Cartridge filters (filter members) 7 are attached to the ceiling plate 6. Spray nozzles 8 for spraying binding liquid or coating liquid onto a particulate material are arranged in the casing 3. In the container 4, a particulate material to be the object of processing is fed. A perforated plate 9 is arranged at the bottom of the container 4.

The top end of the casing 2 is closed by a roof 11. A filter chamber 12 is formed in the inside of the casing 2. An exhaust duct 13 is connected to the filter chamber 12, while a washing water supply pipe 14 is arranged at the lateral wall thereof. The disk-shaped ceiling plate 6 is contained in the filter chamber 12. The peripheral edge of the ceiling plate 6 is held in contact with the inner surface of the casing 2 and a wire 15 is fitted at an end thereof to the upper surface of the ceiling plate 6. The wire 15 is drawn out to the outside of the apparatus by way of pulleys 16a, 16b. The other end of the wire 15 is connected to a pulley (not shown) that is driven by a motor. Thus, the ceiling plate 6 can be moved up and down vertically in the casings 2, 3. As the motor is operated and the wire 15 is drawn upward, the ceiling plate 6 moves upward in the casings 2, 3. On the other hand, as the motor is operated oppositely, the tension of the wire 15 is loosened and the ceiling plate 6 moves downward in the casings 2, 3 by its own weight.

A filter member 17 that is made of unwoven polyester fabric is used for each of a pair of filters 7. The filter member 17 is produced by forming pleats in an unwoven filter fabric and shaping it to show a cylindrical profile. The longitudinal dimension of the filter member 17 is about 130 to 550 mm for a small apparatus and 220 to 1,200 mm for a large apparatus. The outer diameter of the filter member 17 is about 75 to 120 mm for a small apparatus and 200 to 325 mm for a large apparatus. End caps 18a, 18b made of stainless steel are fitted respectively to the upper and lower ends of the filter member 17. A retainer 19 also made of stainless steel is driven into the filter member 17 so as to run through the center thereof. The upper end of the retainer 19 is rigidly fitted to the ceiling plate 6, while a filter anchoring knob 20 is fitted to the lower end of the retainer 19. As the knob 20 is driven upward, the filter member 17 is rigidly secured to the ceiling plate 6, using the retainer 19 as guide. A rubber packing ring 21 is arranged between the cap 18a and the ceiling plate 6.

Pulse jet nozzles 22 are also arranged at the casing 2 to blow out pulsated air for backwashing. Apertures 23 are formed in the ceiling plate 6 so as to face the respective centers of the corresponding filter members 17. A nozzle 22 is arranged above each of the apertures 23. The nozzles 22 are connected to a pulsated air supply source (not shown) to inject pulsated air into the inside of the respective filters 7. As a result, a backwashing process is executed to blow off the particulate material adhering to the filter members 17.

A fluidization chamber 24 is formed in the casing 3 so as to operate also as spraying chamber. The nozzles 8 are attached to spray arms 25. Binding liquid or coating liquid is supplied to the nozzles 8 from a pump arranged outside the apparatus by way of a tube (not shown). The arms 25 are slidably fitted to respective columns (not shown) and the nozzles 8 can be vertically and appropriately moved up and down in the casing 3. Note that the arms 25 and the nozzles 8 can be moved to respective positions that do not constitute any obstacle to the operation of lowering the ceiling plate 6 or appropriately removed to the outside of the apparatus by way of windows (not shown). Note that the nozzles 8 may be arranged at the lateral surface so as not to constitute any obstacle to the operation of moving the ceiling plate 6.

Ultrasonic washers 55 are fitted to the lateral wall 3a of the casing 3. Each of the washers 55 is provided with an ultrasonic oscillator, which is connected to an oscillation generator 58 arranged outside the apparatus. Each of the ultrasonic oscillators may be an oscillator for transforming an electric input into mechanical oscillation such as a piezoelectric ceramic element, which is an electric-mechanical transducer. A high frequency signal of about 15 to 50 kHz is input to the ultrasonic oscillators from the oscillation generator 58 and the electric oscillation is transformed into mechanical oscillation before it is output. As washing liquid is injected into the casing 3 and the washers 55 are driven to operate, the washing liquid is oscillated by the high frequency ultrasonic waves emitted from them and the object of washing in the washing liquid is washed by cavitations and micro-oscillation of the washing liquid. Particularly, the filters 7 that are processed to show pleats so as to have a complex profile can effectively and suitably be washed to the bottoms of the pleats by ultrasonic washing.

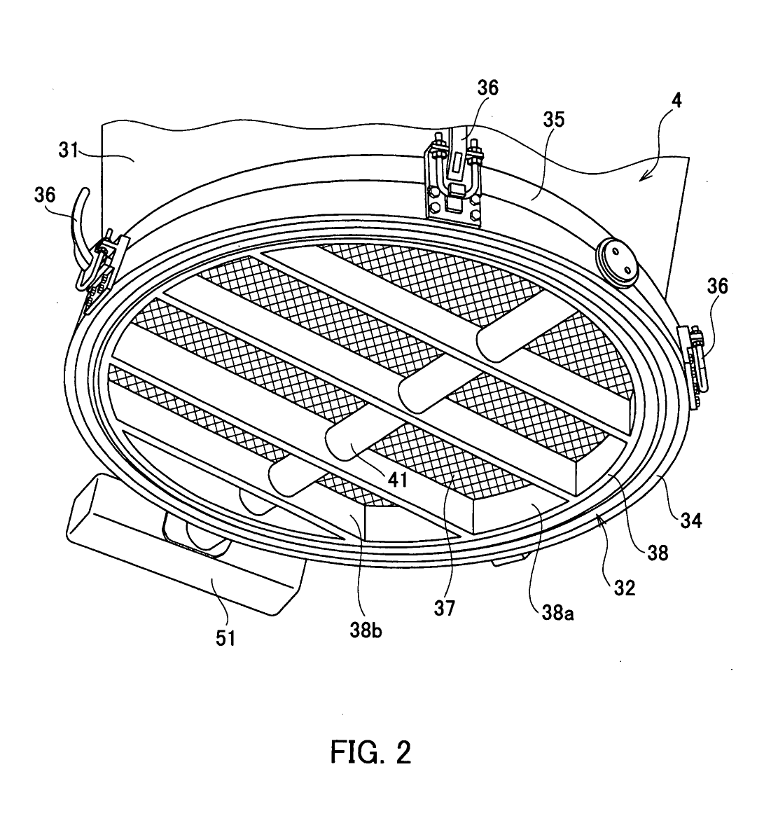

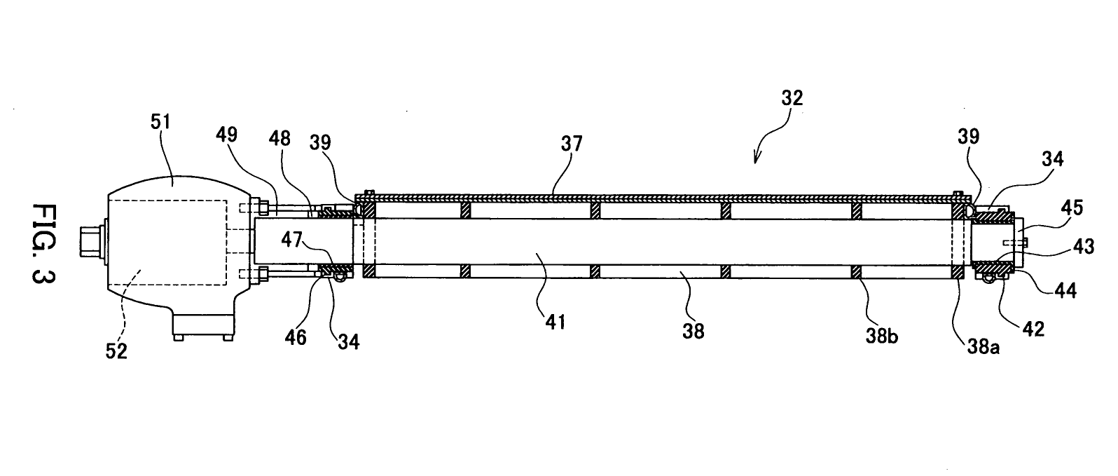

The material container 4 includes a container casing 31 and a screen unit 32 fitted to the lower end of the casing 31. The casing 31 has an inverted circular truncated cone profile with a diameter that diminishes toward the lower end thereof. A material containing chamber 33 is formed in the casing 31. The screen unit 32 includes an annular frame 34 and a perforated plate 9 arranged in the frame 34. The perforated plate 9 has air-permeability and the particulate material put into the containing chamber 33 is supported on the perforated plate 9. FIG. 2 is a schematic perspective view of the material container of the fluidized bed apparatus as viewed from the screen unit 32 side (lower side) thereof and FIG. 3 is a schematic illustration of the screen unit 32 of the fluidized bed apparatus, showing the configuration thereof. As shown in FIG. 2, the screen unit 32 is rigidly secured to the flange section 35 formed at the lower end of the casing 31 by means of toggle cramps 36.

The perforated plate 9 is typically made of folded wire fabric of 42×175-mesh, 32×132-mesh or 24×110-mesh. A porous plate 37 formed by laying a punched plate and a plain woven wire fabric one on the other to reinforce the perforated plate and a support bracket 38 made of stainless steel for supporting the porous plate 37 are fitted to the perforated plate 9. The bracket 38 has a circular outer peripheral section 38a and a plurality of rib sections 38b arranged in parallel with each other in the inside of the outer peripheral section 38a. The air-permeable porous plate 37 is laid on the upper surface of the bracket 38. As shown in FIG. 3, a screen seal 39 is fitted to the entire outer periphery of the outer peripheral section 38a of the bracket 38. As the seal 39 is brought into contact with the inner peripheral surface of the frame 34, the outer periphery of the perforated plate 9 is sealed to prevent the particulate material from falling down and air from leaking into the inside from the outside of the perforated plate.

As shown in FIG. 3, a rotary shaft 41 is fitted to a central part of the bracket 38. The rotary shaft 41 is rotatably supported at the right end side thereof in FIG. 3 (the front side in FIG. 2) by the frame 34 by way of a bush 42. A sleeve 43 made of synthetic resin is arranged between the bush 42 and the rotary shaft 41. A thrust bearing 44 is fitted to the outer end of the sleeve 43. An end cap 45 is fitted to the outer side of the bearing 44.

The rotary shaft 41 is also rotatably supported at the left end thereof by the frame 34 by way of another bush 46. A sleeve 47 made of synthetic resin is arranged between the bush 46 and the rotary shaft 41. A collar 48 is fitted to the outer end of the sleeve 47. A spacer tube 49 is fitted to the outer surface of the collar 48. A motor unit 51 is fitted to the left side of the tube 49 in FIG. 3. The rotary shaft 41 is linked at the left end thereof in FIG. 3 to a motor 52 (drive apparatus) contained in the motor unit 51. The perforated plate 9 is adapted to be driven to rotate around the rotary shaft 41 by the motor 52. It is held to the state illustrated by solid lines in FIG. 1 for a coating process, whereas it is displaced to the state illustrated by a dotted chain line in FIG. 1 for washing the filters.

An air supply unit 5 having an air supply chamber 53 in the inside is installed below the container 4. The unit 5 is connected to an air supply duct 54 that communicates with the air supply chamber 53. The duct 54 is connected to an air supply source (not shown) arranged outside the apparatus. Alternatively, a pneumatic cylinder may be arranged in the air supply chamber 53 to push up the unit 5 and bring it into contact with the container 4 by means of the cylinder. Then, it may be so arranged that the container 4 and the casing 3 and the casings 2 and 3 may be brought into tight contact with each other as the unit 5 is raised.

Air flows into the material containing chamber 33 by way of the perforated plate 9 as fluidizing air is supplied to the air supply chamber 53 from the duct 54 in the fluidized bed apparatus. Then, the particulate material in the chamber 33 is blown up and fluidized in the material containing chamber 33 and the fluidization chamber 24. A process of coating the particulate material is executed as binding liquid or a coating liquid is sprayed onto the material from the nozzles 8 under this condition. It is also possible to subject the processed material to a drying process by stopping the operation of spraying liquid from the nozzles 8 after the process of coating the particulate material.

On the other hand, the air that is used to fluidize the particulate material is cleaned by separating and removing fine solid particles from it by means of the filters 7 and exhausted to the outside by way of the duct 13. The fine particles adhering to the filters 7 are appropriately subjected to a backwashing process by means of the nozzles 22. However, it is difficult to completely blow off the adhering powdery material only by way of a backwashing process. Thus, the filters 7 are washed in the fluidized bed apparatus when a predetermined period of time is spent for a coating process or coating processes. In known fluidized bed apparatus, it is necessary to remove the filters 7 from the apparatus for washing. However, in the fluidized bed apparatus of this embodiment, it is possible to wash the filters 7 in the apparatus, supplying washing water into the casings from the supply pipe 14.

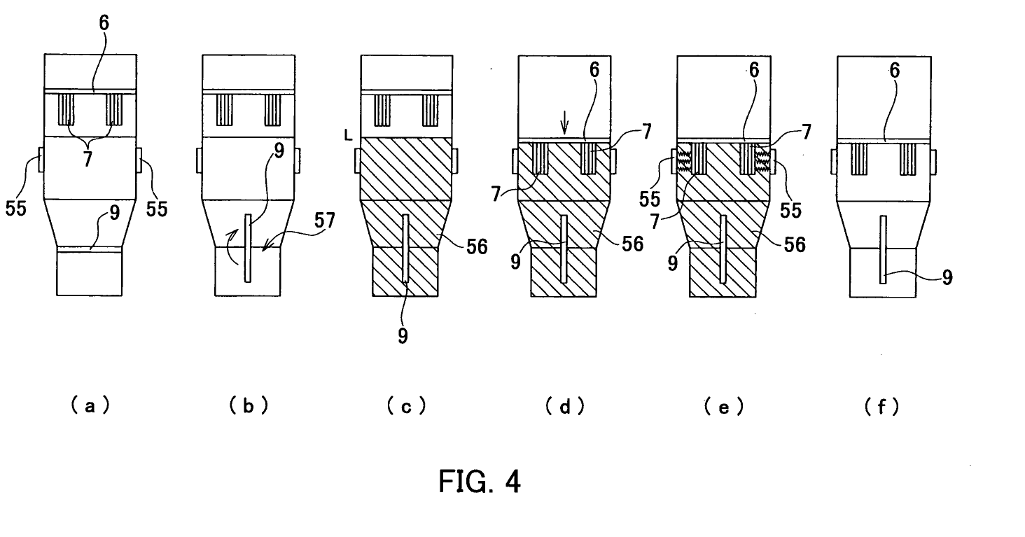

Now, the process of washing the filters 7 of the fluidized bed apparatus of FIG. 1 will be described below. FIGS. 4A through 4F are schematic illustrations of the fluidized bed apparatus of FIG. 1 in different washing steps. When a predetermined period of time is spent for a coating process or coating processes in the fluidized bed apparatus, the product in the inside is taken out and washing liquid 56 is injected into the apparatus by way of the supply pipe 14. At this time, the perforated plate 9 is driven to rotate from the state of FIG. 4A to the state of FIG. 4B before the injection of the washing liquid 56. More specifically, the motor 52 is operated to drive the rotary shaft 41 to rotate by 90° to change the attitude of the perforated plate 9 from the horizontal position of FIG. 4A (the first position) to the vertical position of FIG. 4B (the second position). Then, as a result, a gap is formed between the inner wall of the material container 4 and the outer periphery of the perforated plate 9 and an opening 57 is produced at the bottom of the material container 4. Thus, the fluidization chamber 24 and the material container chamber 33 and the air supply chamber 53 are held in communication with each other by way of the opening 57 in the fluidized bed apparatus. Then, washing liquid 56 is injected into the apparatus from the supply pipe 14.

Warm water, clean water or water containing detergent may be used as washing liquid 56. Washing liquid 56 is injected into the apparatus to predetermined level L as shown in FIG. 4C. After injecting washing liquid 56, the filters 7 are immersed in the washing liquid 56 (FIG. 4D). The filters 7 are lowered with the ceiling plate 6 by operating the wire 15. The ceiling plate 6 is lowered to a position where it is dipped in the washing liquid 56. After immersing the filters 7 in the washing liquid 56, the washers 55 are driven to operate as shown in FIG. 4E. At this time, since the washers 55 are located near the respective filters 7 immersed in the washing liquid 56, the ultrasonic oscillation can easily be transmitted to the filters 7 and the foreign objects adhering to the filters 7 such as fine particles can be removed efficiently.

Additionally, since the perforated plate 9 is made to take a vertical position in the processing vessel 1 during the washing process as shown in FIG. 4E, the efficiency and the performance of the process of washing the perforated plate 9 are improved if compared with an arrangement where the washing process is conducted while the perforated plate 9 is held to take a horizontal position. For example, if powder that is insoluble to washing liquid (the component insoluble to washing liquid) is deposited on the perforated plate 9, such powder cannot be removed satisfactorily when the perforated plate 9 is held to take a horizontal position during the washing process. To the contrary, since the perforated plate 9 is made to take a vertical position in the washing process in the fluidized bed apparatus of FIG. 1, the component insoluble to washing liquid is shaken off and removed from the perforated plate 9 by ultrasonic oscillation. In short, any component insoluble to washing liquid is prevented from being deposited on the perforated plate 9 to make it possible to wash the inside of the apparatus efficiently.

As described above, it is now possible to efficiently wash the filters 7 in the apparatus because the washers 55 are fitted to the lateral wall 3a of the casing 3 and the filters 7 are immersed in the washing liquid that fills the inside of the casing 3 so that the filters 7 can be washed by ultrasonic oscillation while the filters 7 are in the immersed condition. In other words, it is no longer necessary to remove the filters 7 from the apparatus and the filters 7 are automatically washed to remarkably reduce the number of man-hour necessary in the washing process. Additionally, the operator is or the operators are not required to touch the solution of chemical agent during the washing process to improve the environment of operation because the filters 7 are washed in the apparatus. Additionally, a fluidized bed apparatus according to the present invention can be realized by installing washers 55 in a conventional fluidized bed apparatus, the present invention is applicable to conventional fluidized bed apparatus without changing the design to a large extent and replacing a number of components.

After operating the washers 55 for a predetermined time period and washing the filters 7, the washing liquid 56 is discharged by opening a cock (not shown), as shown in FIG. 4F, when the washing process ends. However, if necessary, the steps of FIG. 4C through FIG. 4F may be repeated for a given number of times or the washing process may be executed while constantly supplying and discharging water. It is also possible to dry the filters 7 after cleaning them by flowing drying gas into the apparatus from the duct 54.

### Embodiment 2

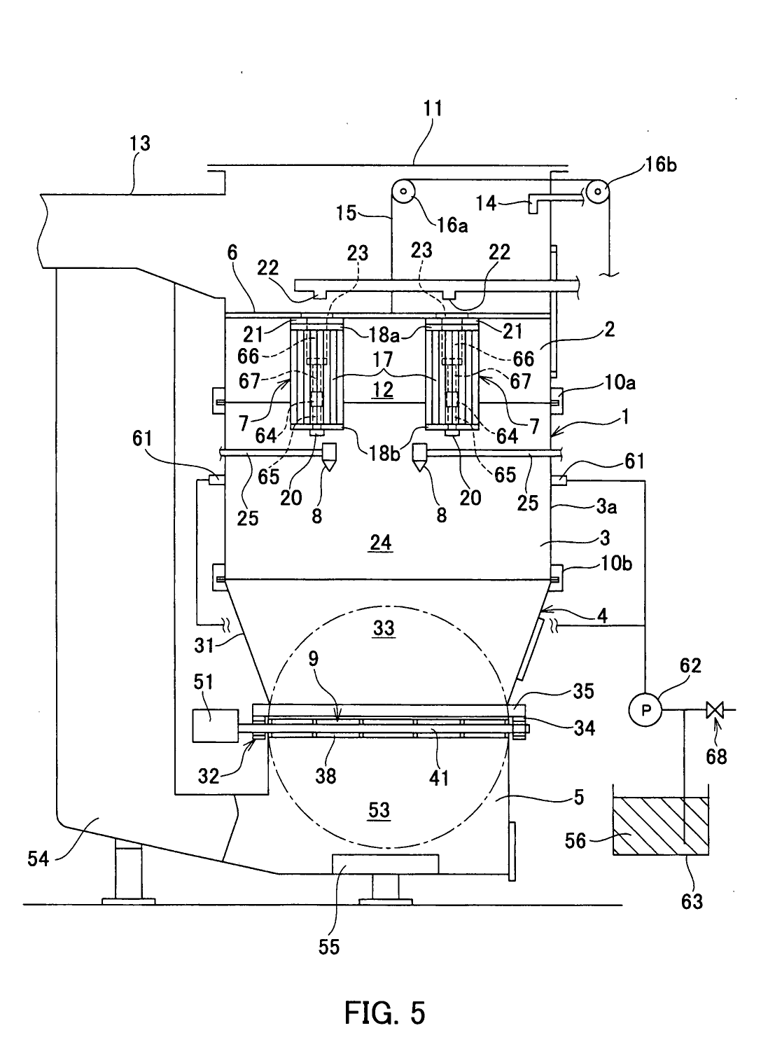

Now, Embodiment 2 of the present invention will be described below. In Embodiment 2, the ultrasonic washers 55 of Embodiment 1 are replaced by bubbling washers 61. FIG. 5 is a schematic illustration of Embodiment 2 of the present invention, which is a fluidized bed apparatus, showing the configuration thereof. The components and the members of Embodiment 2 that are similar to those of Embodiment 1 are denoted respectively by the same reference symbols and will not be described any further.

As shown in FIG. 5, the fluidized bed apparatus is equipped at the lateral wall 3a of the casing 3 with washers 61. Each of the washers 61 has a nozzle (bubble flow injection nozzle) for injecting a liquid flow containing bubbles and is connected to a pump 62 arranged outside the apparatus. The pump 62 is connected to a tank 63 storing washing liquid. Bubble flow injection nozzles that can be used for this embodiment include “Bubbling Jet Nozzle” (trade name) available from Spraying Systems Co., Japan. adapted to take in external air by the effect of a liquid flow and inject fine bubbles as jet flow. Washing liquid is supplied to the bubble flow injection nozzles from the pump 62 under liquid pressure of about 0.1 to 0.5 MPa and air is taken in from air inlet port 68 that is open to the atmosphere by the effect of the liquid flow. Consequently, a liquid flow (bubble flow) including bubbles is injected.

On the other hand, filters 7 are rotatably fitted to the fluidized bed apparatus of Embodiment 2. As shown in FIG. 5, a rotary joint 64 is fitted to the lower end of each of the retainers 19. A filter rotary shaft 65 is fitted to the joint 64. The rotary shaft 65 can freely rotate relative to the retainer 19 by way of the joint 64. A filter anchoring knob 20 is fitted to the lower end of the rotary shaft 65. Thus, each of the filters 7 is rotatably suspended from the ceiling plate 6 by means of a retainer 19, a joint 64, a rotary shaft 65 and a knob 20.

A pair of air cylinders 66 is rigidly secured to the lower surface of the ceiling plate 6. Compressed air is supplied to the air cylinders 66 from a compressor (not shown). As shown in FIG. 5, the air cylinders 66 extend downward from the ceiling plate 6 and lower parts thereof are contained in the respective filters 7. A piston rod 67 projects downward from the lower end of each of the air cylinders 66. A joint 64 is fitted to the lower end of the piston rod 67. FIG. 5 shows a state where the piston rod 67 of the air cylinder 66 is contracted and the rotary shaft 65 is pulled upward. On the other hand, as the air cylinders 66 are operated, the piston rods 67 come to project out from the respective air cylinders 66 and the rotary shafts 65 move down. Then, as a result, the filters 7 move down and the rubber packing rings 21 are released from the ceiling plate 6 to make the filters 7 rotatable. The configuration of the other components of this embodiment is same as that of Embodiment 1.

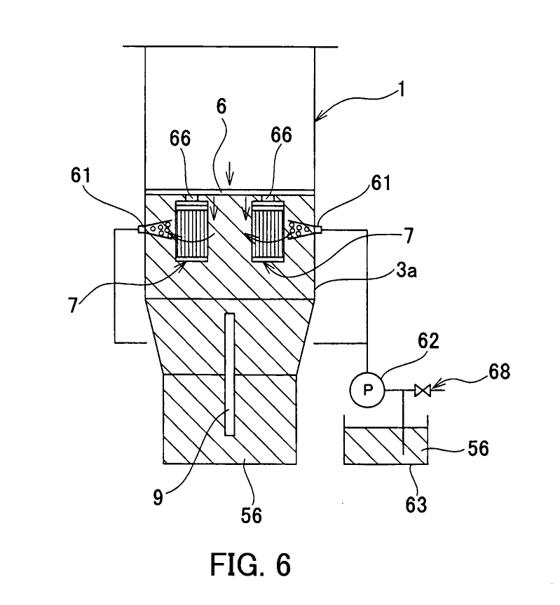

In the fluidized bed apparatus of FIG. 5, the bubble flow injection nozzle of each of the washers 61 is inclined relative to the lateral wall 3a in such a way that an air bubble flow strikes the filter 7 in a tangential direction in a filter washing process. FIG. 6 is a schematic illustration of a filter washing process of this fluidized bed apparatus. In the fluidized bed apparatus of Embodiment 2, the ceiling plate 6 is lowered and the air cylinders 66 are operated to release the filters 7 from the ceiling plate 6 and make them rotatable in a washing process. Then, as washing liquid is injected into the casing 3 and the washers 61 are operated, the filters 7 are driven to rotate around the respective rotary shafts 65 by the air bubble flows produced from the washers 61, while they are supported by the respective joints 64. As the filters 7 rotate, the fine particles accumulated in the bottoms of the pleats of the filters 7 are driven to move toward the outer periphery by the centrifugal force produced as a result of the revolutions of the filters 7. Thus, the filters 7 are washed not only by the effect of the bubble flows blown into the pleats but also by the centrifugal force produced by the revolutions of the filters 7.

Since the filters 7 are washed while they are driven to rotate by the bubble flows produced by the washers 61 in this fluidized bed apparatus, the bubble flows directly hit the respective filters entirely to consequently wash the bottoms of the pleats. Therefore, it is no longer necessary to remove the filters from the apparatus and the filters are automatically washed to remarkably reduce the number of man-hour necessary in the washing process. Additionally, the operator is or the operators are not required to touch the solution of chemical agent during the washing process to improve the environment of operation because the filters are washed in the apparatus. Additionally, a fluidized bed apparatus according to the present invention can be realized by installing washers 61 in a conventional fluidized bed apparatus, the present invention is easily applicable to conventional fluidized bed apparatus without changing the design to a large extent and replacing a number of components.

### Embodiment 3

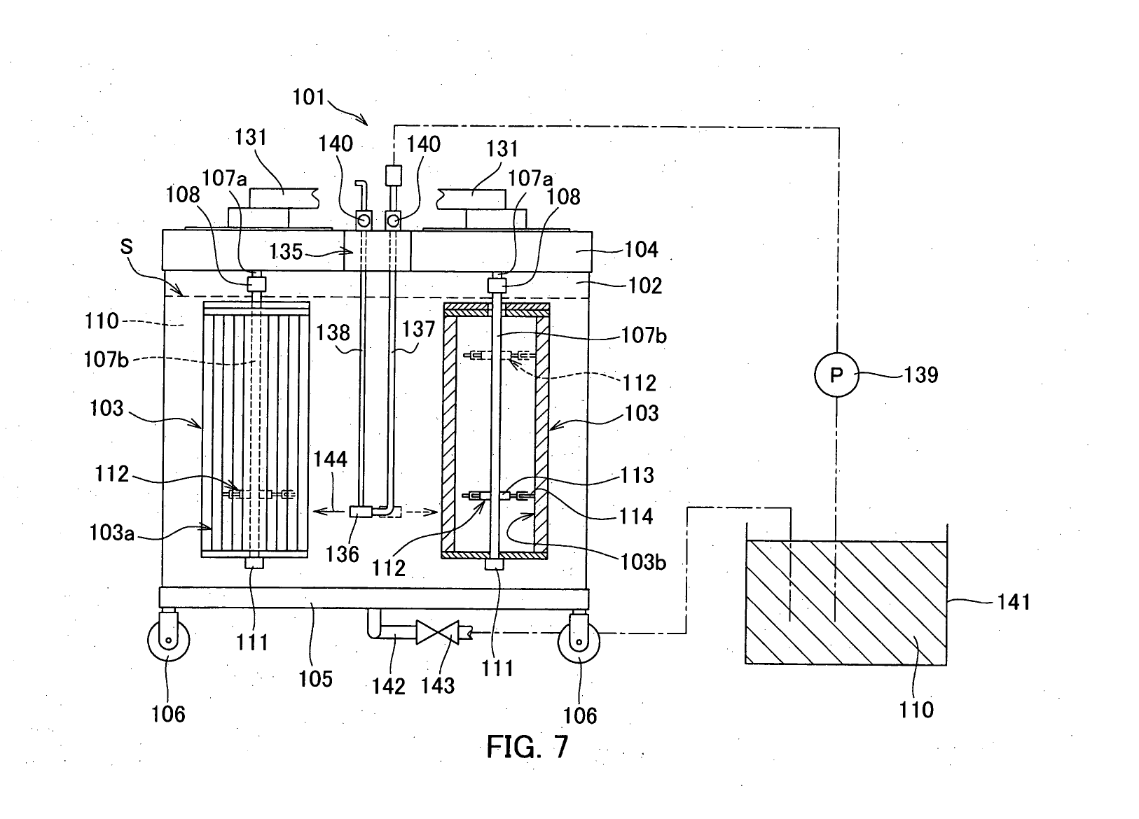

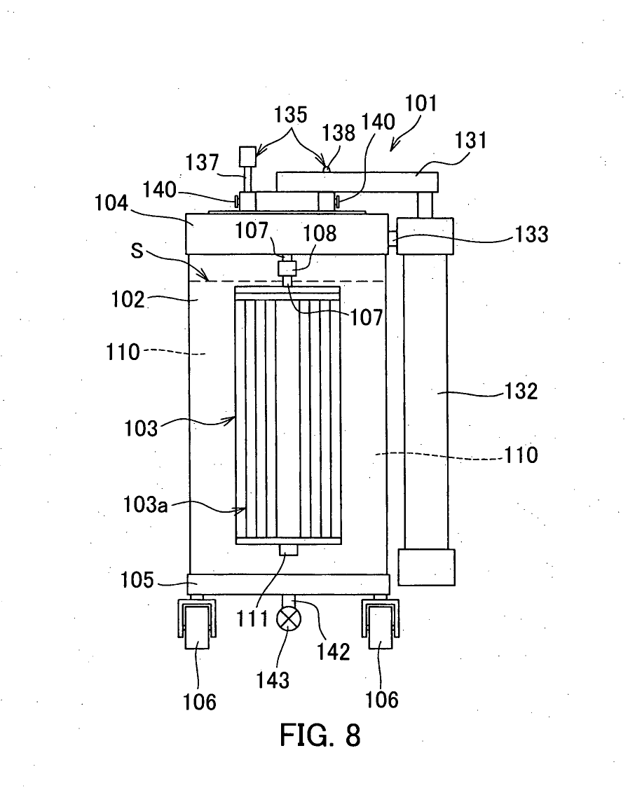

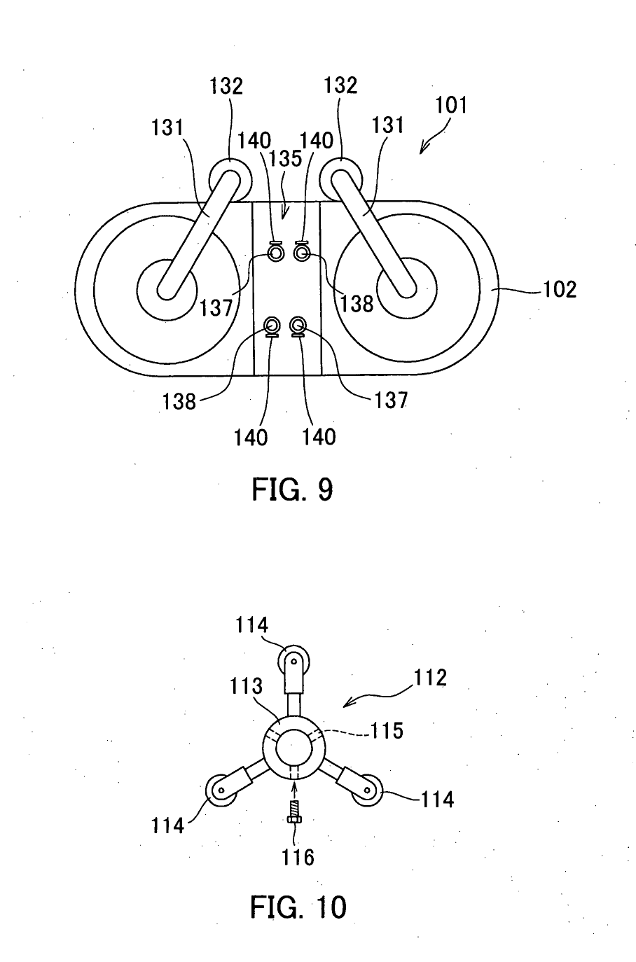

FIG. 7 is a schematic illustration of Embodiment 3, which is filter washing apparatus, showing the configuration thereof. FIG. 8 is a schematic illustration of the filter washing apparatus of FIG. 7 as viewed from the right side in FIG. 7. FIG. 9 is a schematic illustration of the filter washing apparatus of FIG. 7 as viewed from above in FIG. 7. The filter washing apparatus 101 of FIG. 7 is a cartridge filter washing apparatus to be used for a particulate processing apparatus such as a fluidized bed granulation/coating apparatus. However, it is a stand-alone apparatus and separated from a particulate processing apparatus. Additionally, the washing apparatus 101 is dedicated to cartridge filters. In other words, the cartridge filters taken out from a particulate processing apparatus are washed in the washing apparatus 101.

As shown in FIGS. 7 through 9, the washing apparatus 101 comprises a box-shaped processing vessel 102 having a substantially elliptical cross section. The vessel 102 is filled with washing liquid 110. A pair of cartridge filters 103 (to be referred to simply as filters 103 hereinafter) is immersed in the washing liquid 110 of the washing apparatus 101 and subjected to a washing process while they are driven to rotate typically by means of bubble jets. The vessel 102 is made of a transparent material such as acryl resin so that the inside of the apparatus including the filters being washed can be observed from the outside of the apparatus. An upper lid 104 and a bottom plate 105 are fitted respectively to the top and the bottom of the vessel 102. The upper lid 104 and the bottom plate 105 are made of a metal such as stainless steel. The upper lid 104 is detachable with respect to the vessel 102 and the filters 103 are attached to the side of the vessel 102 of the upper lid 104. On the lower surface side of the bottom plate 105, casters 106 are attached. The washing apparatus 101 can be moved whenever necessary.

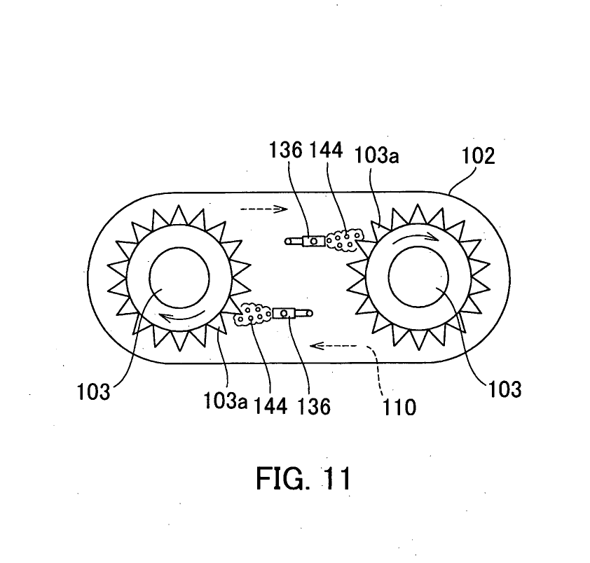

Filters 103 are rotatably fitted to the upper lid 104. A filter member that is made of unwoven polyester fabric and shaped to show a cylindrical profile is used for each of the pair of filters 103. A pleats section 103a (see FIG. 11) of a number of pleats produced by folding the fabric is arranged along the outer periphery of each of the filters 103. The longitudinal dimension of each of the filters 103 is about 130 to 550 mm for a small apparatus and 220 to 1,200 mm for a large apparatus. The outer diameter of the filter 103 is about 75 to 120 mm for a small apparatus and 200 to 325 mm for a large apparatus. Each of the pleats of the pleats section 103a is about 13 to 25 mm for a small apparatus and 45 to 55 mm for a large apparatus.

As shown in FIG. 7, retainers 107a, 107b (107a: first retainer, 107b: second retainer) are arranged under the upper lid 104 to support the respective filters 103. The retainers 107a, 107b are rod-shaped and a rotary joint 108 is fitted to the top end of each of the retainers 107b. The retainers 107b are rotatable relative to the upper lid 104 due to the joints 108 that are located above the liquid surface level S of the washing liquid 110. Filter anchoring knobs 111 are fitted respectively to the lower ends of the retainers 107b. As the knobs 111 are tightened, the filters 103 are rigidly secured to the respective retainers 107b. Thus, each of the filters 103 is rotatably suspended from the lower side of the upper lid 104 by means of a retainer 107a, a joint 108, a retainer 107b and a knob 111.

Each of the retainers 107b is additionally provided with a support roller unit 112 for rotatably supporting the corresponding filter 103 from the inside. FIG. 10 is a schematic illustration of one of the support roller units 112. As shown in FIG. 10, each of the support roller units 112 comprises a cylindrical retainer mount section 113 that is made of metal so that it can be fitted to the retainer 107b from the outside. Three rollers 114 are rotatably arranged around the outer periphery of the retainer mount section 113 and separated equidistantly from each other. The retainer mount section 113 is also provided with three bolt-receiving holes 115 that are separated equidistantly from each other. The bolt-receiving holes 115 radially run through the retainer mount section 113 and are threaded at the inner surfaces thereof. Each of the support roller units 112 is rigidly secured to the outer periphery of the corresponding retainer 107b as bolts 116 are driven into the respective bolt-receiving holes 115.

As each of the units 112 is fitted to the corresponding retainer 107b, the rollers 114 arranged respectively at three positions come to contact with the inner peripheral surface 103b of the filter 103. In other words, the filter 103 is supported by the unit 112 from the inner peripheral side. Then, the shaking motion of the filter 103 is minimized when the filter 103 is driven to rotate so that it can rotate stably and smoothly. Additional support roller units 112 may be arranged at respective positions indicated by broken lines in addition to the units 112 arranged at the respective positions indicated by solid lines in FIG. 7 in order to improve the stability of the rotary motion of the filters.

On the other hand, an air cylinder 132 is connected to the upper end of each of the retainer 107a by way of a support arm 131. The air cylinder 132 is rigidly secured to a lateral side of the upper lid 104 by means of a bracket 133. Thus, the retainer 107a, 107b can be vertically moved by the air cylinder 132. In other words, the filters 103 are vertically movably fitted to the inside of the vessel 102. Note that the air cylinders 132 are not indispensable and may be omitted to simplify the overall configuration of the apparatus and reduce the product cost.

A bubbling-washing unit 135 is fitted to the center of the upper lid 104 so as to be vertically movable. The unit 135 includes a pair of bubbling jet nozzles (nozzle devices) 136, a pair of liquid feed pipes 137 and a pair of suction pipe 138. The liquid feed pipes 137 are connected to a washing liquid tank 141 by way of a pump 139. Thus, washing liquid 110 is pressurized and supplied from the tank 141 to the liquid feed pipes 137 by means of the pump 139. The suction pipes 138 are open to the atmosphere at the upper end and hence the nozzles 136 are held in communication with the atmosphere by way of the suction pipe 138. The liquid feed pipes 137 and the suction pipes 138 are adapted to be rigidly secured at desired respective positions by means of anchor screws 140. On the other hand, a drain pipe 142 is fitted to the bottom plate 105. The drain pipe 142 is connected to the tank 141 by way of a valve 143. Thus, washing liquid 110 is supplied into the container 102 by means of the nozzles 136, discharged from the drain pipe 142 and returned to the tank 141 to circulate for reuse.

Powder is adhering to the filters 103 to a large extent after a granulation/coating process. Therefore, waste washing liquid 110 may not be circulated but disposed so that clean washing liquid 110 may be supplied from the tank 141 in the initial stages of a washing process. Then, the filters 103 can be washed efficiently. The liquid circulation system of FIG. 7 may be activated when the substances adhering to the filters 103 are removed to a certain extent. Thus, it is possible to improve the washing efficiency and suppress the consumption of washing liquid by appropriately changing the mode of supply of washing liquid 110 according to the stage of progress of washing operation. When washing liquid 110 is circulated for reuse, washing liquid 110 may be directly fed from the valve 143 to the pump 139 instead of circulating washing liquid 110 by way of the tank 141. In other words, the vessel 102 may be regarded as a large liquid tank as a whole.

Washing liquid 110 is pressurized and supplied to the nozzles 136 from the respective liquid feed pipes 137. External air is suctioned at the nozzles 136 from the suction pipes 138 by means of liquid flows and bubble flows are generated by mixing washing liquid 110 and external air and injected into the washing liquid 110 in the vessel 102 as jet flow. FIG. 11 is a schematic illustration of the jet injection of the bubbling jet nozzles 136 of the filter washing apparatus of this embodiment. As shown in FIG. 11, a jet flow 144 is blown to each of the filters 103 in the vessel 102 substantially in a tangential direction. The jet flows 144 strikes the pleats 103a of the filters 103 that are rotatably arranged so that the filters 103 are driven to rotate in the sense as indicated by arrows in FIG. 11 by the jet flows 144. The nozzles 136 are arranged so as to make the filters 103 rotate in the same sense. Thus, a liquid flow as indicated by arrows of broken lines in FIG. 11 is produced in the vessel 102.

A process of washing the filters 103 proceeds in the washing apparatus 101 in a manner as described below. Firstly, the filters 103 where fine particles are adhering are taken out form the fluidized bed granulation apparatus or the like and mounted in the washing apparatus 101. More specifically, the filters 103 are fitted to the outside of the respective retainers 107b and the knobs 111 are tightened to rigidly secure the filters 103 to the upper lid 104. Thereafter, the filters 103 are immersed into the vessel 102 filled with washing liquid 110 and the upper lid 104 is fitted to the top of the vessel 102. After containing the filters 103 in the washing apparatus 101 in this way, the pump 139 is activated to inject jet flows 144 from the respective nozzles 136 at a predetermined rate, e.g., about 10 L/min.

As pointed out above, if a filter 103 is formed with pleats, a backwashing air flow can hardly get to the bottoms of the pleats 103a of the filter 103 and the fine powder adhering to the bottoms may not be blown off satisfactorily. However, in the washing apparatus 101, washing liquid 110 is injected to the filters 103 from the respective nozzles 136 to wash off the fine powder adhering to the bottoms of the pleats 103a. A jet flow 144 is injected to each of the filters 103 in a tangential direction as shown in FIG. 11. Thus, the filters 103 are driven to rotate around the respective retainers 107b like so many water mill wheels by the jet flows 144, while they are supported by the joints 108. As the filters 103 revolve, the fine powder accumulated in the bottoms of the pleats 103a are driven to the outer peripheral sides of the filters 103 with washing liquid 110 by the centrifugal forces generated as a result of the revolutions. In other words, the washing liquid 110 injected to the pleats 103a gets to the bottoms of the pleats and then expelled from the filters 103 with fine powder by the centrifugal forces.

In the washing apparatus 101, the filters 103 are moved up and down by the air cylinders 132, while the jet flows 144 are injected. Then, as a result, the filters 103 frictionally and vertically slide in the washing liquid 110 to improve the washing effect. Initially, the nozzles 136 are arranged as shown in FIG. 7 and the lower parts of the filters 103 are washed. Thereafter, the bubbling-washing unit 135 is moved upward to wash the filters 103 from below to above. The operator may manually pull up the unit 135, observing the washed condition of the filters 103 from the outside of the transparent vessel 102, and hold it to an appropriate position by means of the anchor screws 140. Alternatively, a drive means such as an air cylinder may be connected to the unit 135 so as to mechanically drive the unit 135 to move up and down.

Thus, in the washing apparatus 101, washing liquid 110 is injected to the filters 103 in a tangential direction thereof to drive the filters 103 to rotate by means of the nozzles 136 for washing so that the fine powder adhering to the bottoms of the pleats of the filters can be removed and the filters can be washed satisfactorily by a rotary washing process that utilizes centrifugal forces. Additionally, the washing apparatus 101 does not have a complex drive unit for driving the filters 103 to revolve so that it is possible to execute a high precision washing process on the filters 103 by means of such a low cost apparatus. The washing apparatus 101 has a simplified configuration and can be manufactured at low cost because it is dedicated to cartridge filters.

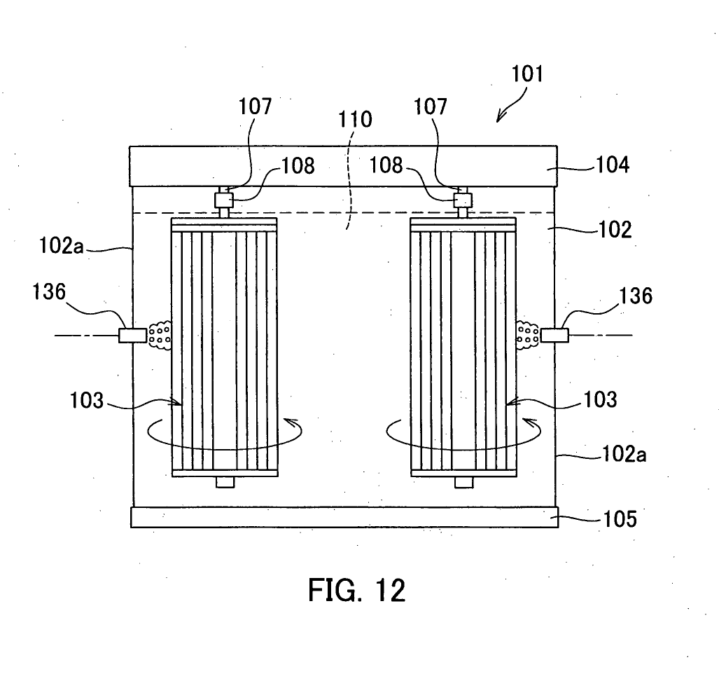

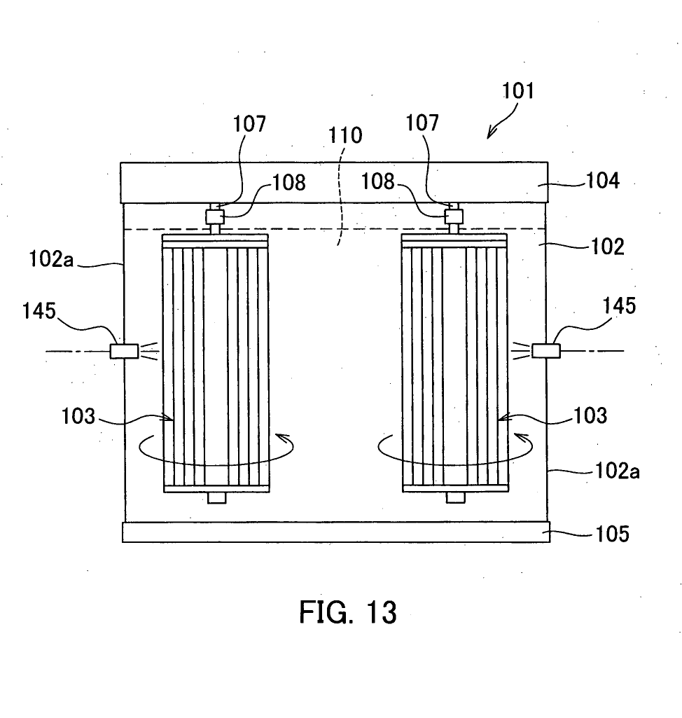

While the nozzles 136 are arranged substantially at the center of the washing apparatus 101 of FIG. 7, they may alternatively be arranged at the wall surface 102a of the vessel 102 as shown in FIG. 12. The bubbling jet nozzles 136 may be replaced by liquid flow generation nozzles (nozzle devices) 145 that pressurize washing liquid 110 for injection. Then, such nozzles 145 may be arranged at the wall surface 102a of the processing vessel 102 as shown in FIG. 13.

### Embodiment 4

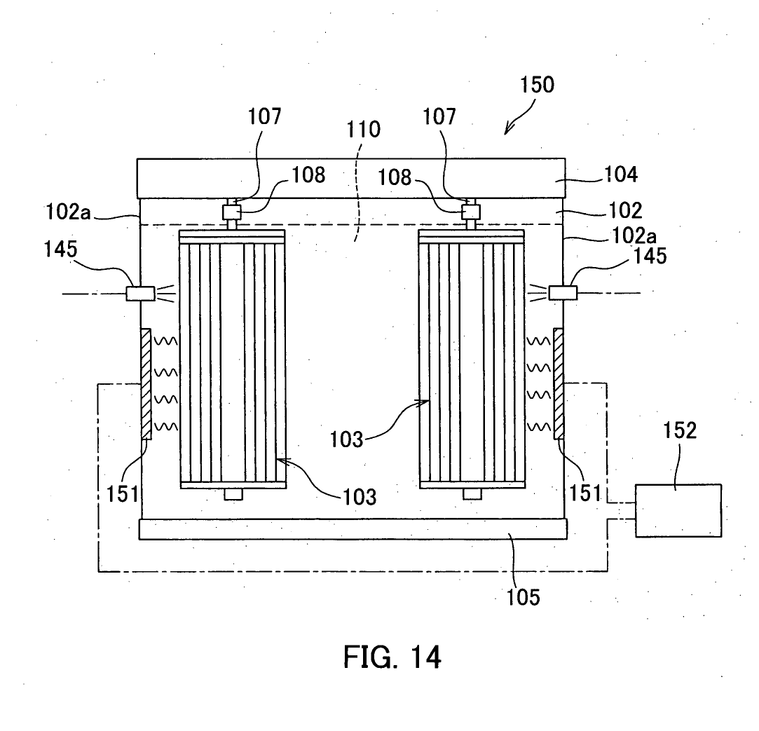

Now, Embodiment 4 of the present invention will be described below. Embodiment 4 is a filter washing apparatus that uses both washing liquid and ultrasonic washing. While nozzles 136 or nozzles 145 are used in the washing apparatus 101 of Embodiment 3, the washing apparatus 101 may be additionally equipped with one or more than one ultrasonic washers for the purpose of raising the washing effect of the apparatus. FIG. 14 is a schematic illustration of Embodiment 4, which is filter washing apparatus 150, showing the configuration thereof. In the following description, the members and the parts similar to those of Embodiment 3 are denoted respectively by the same reference symbols and will not be described any further.

As shown in FIG. 14, the washing apparatus 150 is equipped with ultrasonic washers 151 at the wall surface 102a of the vessel 102 along with nozzles 145. Each of the washers 151 is provided with an ultrasonic oscillator, which is connected to an oscillation generator 152 arranged outside the apparatus. Each of the ultrasonic oscillators may be a piezoelectric ceramic element as described earlier. A high frequency signal of about 15 to 50 kHz is input to the ultrasonic oscillators from the oscillation generator 152.

So-called hybrid washing is conducted in the washing apparatus 150. In other words, rotary washing by the nozzles 145 as in Embodiment 3 and ultrasonic washing by the washers 151 are concurrently conducted in the washing apparatus 150. More specifically, as washing liquid 110 is injected into the vessel 102 and the nozzles 145 and the washers 151 are activated, the filters 103 are driven to rotate by the jet flows from the nozzles 145 and, at the same time, the washing liquid is oscillated by the high frequency ultrasonic waves emitted from the washers 151. Then, the filters 103 in the washing liquid 110 are washed by cavitations and micro-oscillation of the washing liquid in addition to the aforementioned rotary washing. Particularly, the filters 103 that are processed to show pleats so as to have a complex profile can effectively and suitably be washed to the bottoms of the pleats by ultrasonic washing to effectively improve the washing effect. Note that it is not necessary to concurrently activate the nozzles 145 and the washers 151. In other words, they may be activated sequentially or in some other appropriate manner to achieve an improved washing effect.

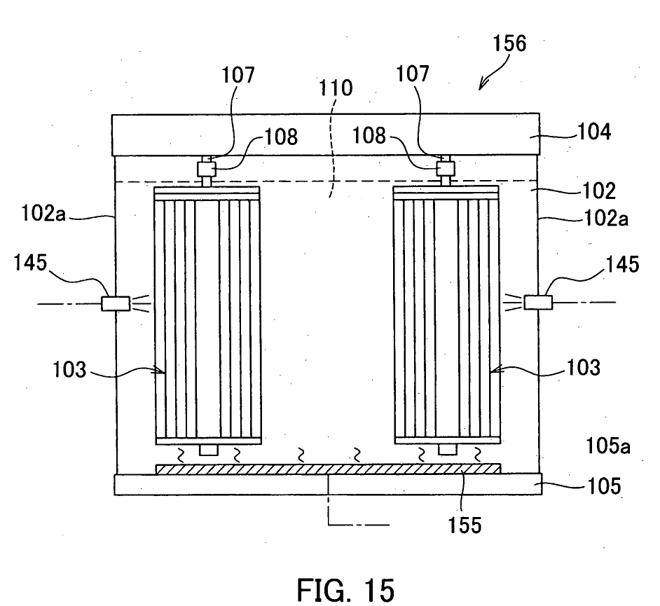

While the washers 151 are arranged at the wall surface 102a of the vessel 102 in the washing apparatus 150, they may alternatively be arranged on the bottom plate 105. FIG. 15 is a schematic illustration of a filter washing apparatus of FIG. 14 as modified by arranging an ultrasonic washer 155 on the bottom plate 105. In the filter washing apparatus 156 of FIG. 15, the nozzles 145 are arranged substantially at the middle positions of the wall surface 102a of the processing vessel 102 and the washer 155 is arranged on the upper surface 105a of the bottom plate 105, or the bottom surface of the vessel 102. In the washing apparatus 156, the filters 103 are driven to revolve by the nozzles 145, while the washing liquid 110 are oscillated from the bottom surface side of the filters by the washer 155 for hybrid washing of washing the filters 103.

### Embodiment 5

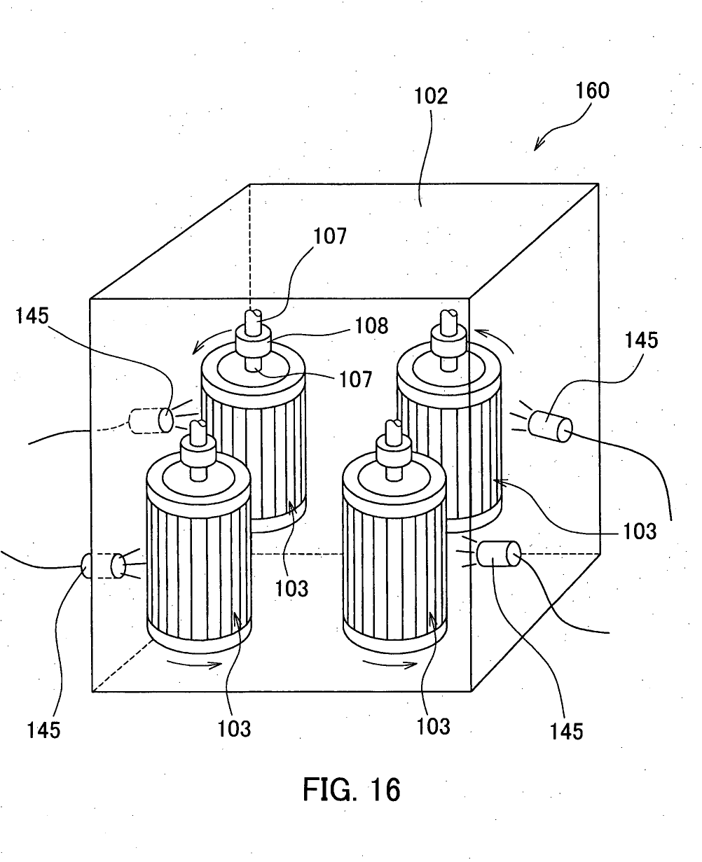

FIG. 16 is a schematic illustration of Embodiment 5, which is filter washing apparatus 160, showing the configuration thereof. While the preceding embodiments can contain two filters 103 in the vessel 102, the number of filters that can be contained is not limited to two. Alternatively, it may be so arranged that a single filter is contained at a time or three or more than three filters are contained at the same time. The washing apparatus 160 of Embodiment 5 is a large apparatus that can contain four filters 103 at a time. A total of four nozzles 145 are arranged at the wall surface 102a of the vessel 102 of the washing apparatus 160 and the filters 103 are driven to revolve in the same sense by the jet flows from the nozzles 145. Such a large apparatus can achieve a higher efficiency in the washing process as the number of filters that can be processed at a time is increased.

### Embodiment 6

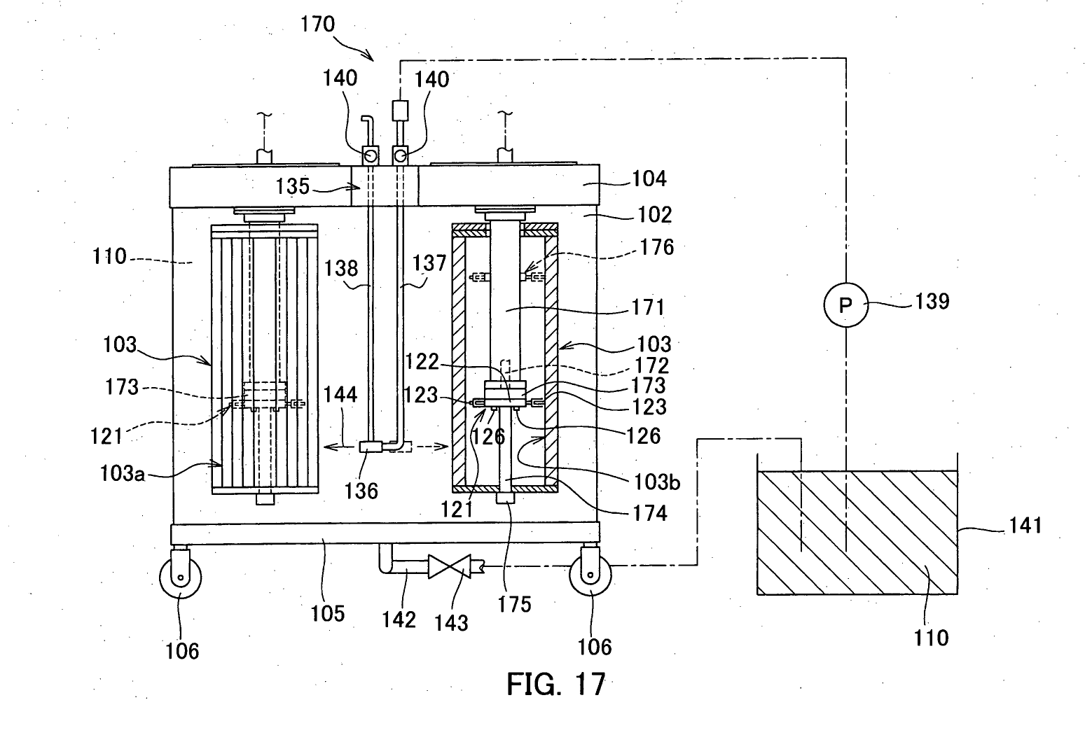

FIG. 17 is a schematic illustration of Embodiment 6, which is filter washing apparatus 170, showing the configuration thereof. Air cylinders 171 for supporting respective filters 103 are arranged in the vessel 102 to move the filters 103 up and down in the washing apparatus 170 of Embodiment 6 so as to make it possible to downsize the apparatus 170.

As shown in FIG. 17, the air cylinders 171 are arranged under the upper lid 104 to support the filters 103. The air cylinders 171 are made to show a cylindrical profile and connected to a compressor (not shown) arranged outside the apparatus. A rotary joint 173 is fitted to the lower end of the piston rod 172 of each of the air cylinders 171. A filter rotary shaft 174 is fitted to the joint 173 so that the rotary shaft 174 is rotatable relative to the air cylinder 171 by way of the joint 173. A filter anchoring knob 175 is fitted to the lower end of the rotary shaft 174 and the filter 103 is rigidly secured to the rotary shaft 174 by tightening the knob 175.

Thus, in the washing apparatus 170 of Embodiment 6, each of the filters 103 is rotatably suspended below the upper lid 104 by means of an air cylinder 171, a joint 173, a rotary shaft 174 and a knob 175. Additionally, the filters 103 can be driven to move up and down by the respective air cylinders 171 so that they are driven to rotate and swing up and down in washing liquid 110 and washed by jet flows 144.

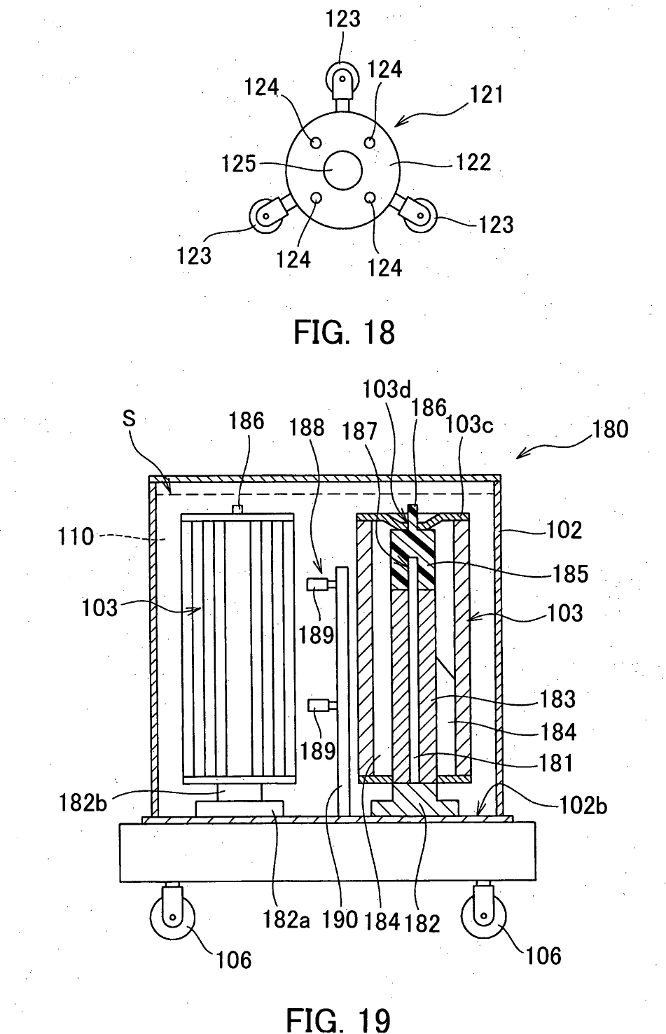

Like the filter washing apparatus of embodiment 3, each of the air cylinders 171 of the washing apparatus of this embodiment is provided with a support roller unit 121. FIG. 18 is a schematic illustration of one of the support roller units 121. As shown in FIG. 10, each of the support roller units 121 comprises a metal-made fitting plate 122 and three rollers 123 that are equidistantly separated from each other. The fitting plate 122 is provided with bolt receiving holes 124 and a rotary shaft receiving hole 125. The fitting plate 122 is fitted to the lower surface of the corresponding joint 173 by means of bolts 126. At the same time, the rotary shaft 174 is loosely driven into the rotary shaft receiving hole 125. The rollers 123 contact the inner peripheral surface 103b of the corresponding filter 103 so that the filter 103 is supported from the inner peripheral side by the support roller unit 121 and can rotate in a stabilized manner.

The filters 103 may shake less and rotate more smoothly when they are supported by rollers 123 at the bottom ends and the top ends thereof at the same time. However, the distance between the upper rollers and the lower rollers of each of the support roller units 121 becomes large when the support roller units 121, 121 are arranged to accommodate large filters. Then, when smaller filters are to be washed, each of them is rigidly secured to the lower end of the corresponding rotary shaft 174 by the knob 175 so that the upper rollers 123 can remain disengaged from the filter 103. Therefore, the rollers 123 of each of the support roller units 121 are preferably arranged at a relatively lower position of the corresponding filter as shown in FIG. 17.

Additional support roller units 176 may be arranged at respective positions indicated by broken lines in addition to the units 121 arranged at the respective positions indicated by solid lines in FIG. 17 in order to improve the stability of the rotary motion of the filters. The units 176 are structurally same as the units 112 shown in FIG. 10 and adapted to be secured to the outer peripheries of the respective air cylinders 171 by means of bolts. Note that the inner diameter of the mount sections of the units 176 is made greater than that of the mount sections 113 of the units 112 to match the diameter of the objects to be mounted (the retainers 107b in Embodiment 3 and air cylinders 171 in Embodiment 6).

### Embodiment 7

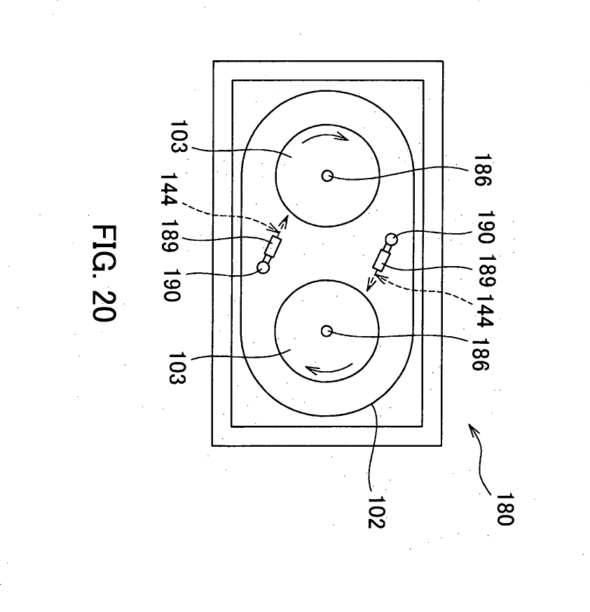

FIG. 19 is a schematic illustration of Embodiment 7, which is filter washing apparatus 180, showing the configuration thereof. FIG. 20 is a schematic illustration of the filter washing apparatus 180 of FIG. 19 as viewed from above. Filters 103 are supported by the bottom section of the vessel 102 in the washing apparatus 180 of Embodiment 7.

As shown in FIG. 19, columns 181 are standing upward from the bottom surface 102b of the vessel 102 to support respective filters 103. The columns 181 are made of stainless steel and put on respective disk-shaped base plates 182 that are also made of stainless steel. The base plates 182 are stepped to show an upper level and a lower level, which they have different diameter. The lower level section 182a of each of the base plates 182 is rigidly secured to the bottom surface 102b and the corresponding column 181 is rigidly secured to the center of the upper level section 182b of the base plate 182. A cylindrical filter guide 183 that is also made of stainless steel is rotatably fitted to the outer surface of the column 181. Three guide pieces 184 that are made of synthetic resin are fitted to the outer periphery of the guide 183 at a lower part thereof and equidistantly separated from each other. The outer peripheral dimension of the circle formed by the guide pieces 184 is substantially same as (slightly smaller than) the inner peripheral dimension of the filter 103.

The height of the guides 183 is smaller than that of the columns 181. Thus, as the guides 183 are fitted to the respective columns 181, the top end parts of the columns 181 project respectively from the top ends of the guides 183. A rotary cap 185 made of synthetic resin is fitted to the front end section of each of the columns projecting from the corresponding guide 183. The cap 185 is cylindrical and has an outer diameter same as the guides 183 and provided with a column receiving hole 187 at the bottom end thereof. The cap 185 is fitted to the top of the corresponding guide 183 as it receives the front end section of the column 181 in the column receiving hole 187 thereof. A filter supporting shaft 186 is projecting from the top surface of the cap 185. The supporting shaft 186 is made to have a diameter slightly smaller than the shaft receiving hole 103d bored at the bottom plate 103c of the corresponding filter 103.

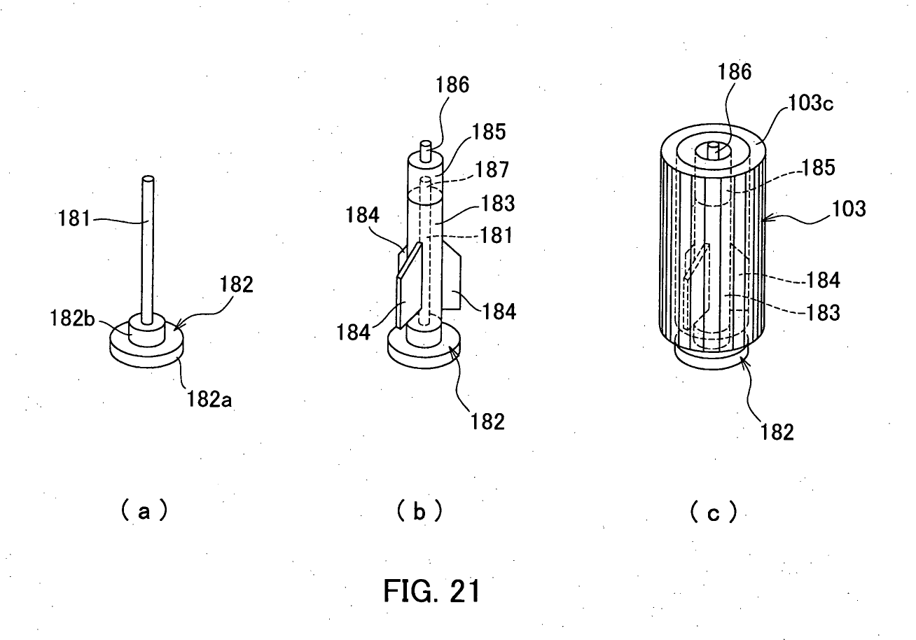

The filters 103 are set in position in the vessel 102 of the washing apparatus 180 in a manner as described below. FIGS. 21A, 21B, 21C are schematic illustrations of one of the filters of the filter washing apparatus of FIG. 19, showing how the filter is set in position. Firstly, the guide 183 and the cap 185 are fitted to the column 181 secured to the bottom surface 102b of the vessel 102 as shown in FIG. 21A in a manner as shown in FIG. 21B. The guide 183 and the cap 185 are loosely engaged with the column 181 so that they are rotatably fitted to the column 181. After setting the guide 183 and the cap 185 on the column 181, the filter 103 is fitted to the guide 183 and the cap 185 so as to cover the latter. Note that the filter 103 is turned up side down so that the supporting shaft 186 is received in the shaft hole 103d of the bottom plate 103c as shown in FIG. 21C.

As the filter 103 is mounted on the guide 183 from outside, the outer edges of the guide pieces 184 come to contact with the inner peripheral surface 103b of the filter 103. The inner peripheral surface 103b of the filter 103 is produced by a punched member or mesh member that is made of metal and the filter 103 is supported by the guide pieces 184 from the inside. Thus, the filter 103 is supported by the supporting shaft 186 at an upper part thereof and also by the guide pieces 184 at a lower part thereof. Since the guide 183 and the cap 185 are rotatably fitted to the column 181, the filter 103 is also supported rotatably relative to the column 181.

A bubbling-washing unit 188 is arranged at a central part of the vessel 102 of the washing apparatus 180 having the above-described configuration. The unit 188 is equipped with bubbling jet nozzles (nozzle devices) 189 and pressurized washing liquid is supplied by way of a liquid feed pipe 190 by means of a pump (not shown). As shown in FIG. 20, a jet flow 144 is blown onto each of the filters 103 in the vessel 102 substantially in a tangential direction from the corresponding nozzle 189. As a result, the filters 103 that are rotatably supported on the columns 181 are driven to rotate in the sense as indicated by arrows in FIG. 20. Thus, the fine particles in the bottoms of the pleats that cannot be washed out by a backwashing can be thoroughly removed by the rotary washing process that utilizes centrifugal forces. Additionally, the washing apparatus 180 does not have a complex drive unit for driving the filters 103 to revolve so that it is possible to execute a high precision washing process on the filters 103 by means of such a low cost apparatus.

As pointed out earlier, while the nozzles 189 are arranged substantially at the center of the washing apparatus 180 of FIG. 19, they may alternatively be arranged at the wall surface of the vessel 102. The bubbling jet nozzles may be replaced by liquid flow generation nozzles that pressurize washing liquid 110 for injection. Additionally, the washing apparatus 180 may be equipped with both nozzles 189 and ultrasonic washers.

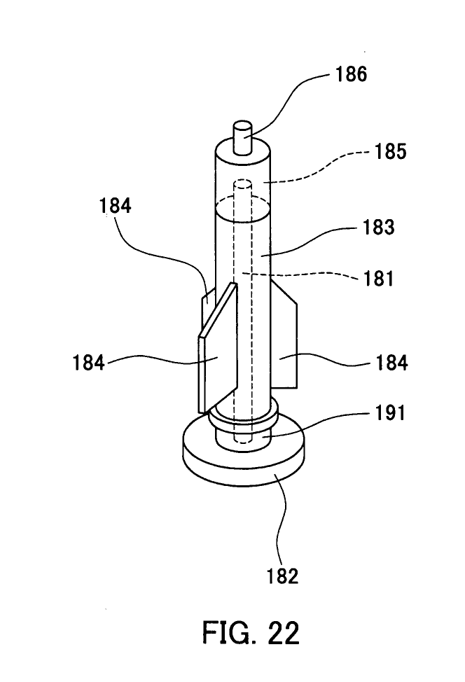

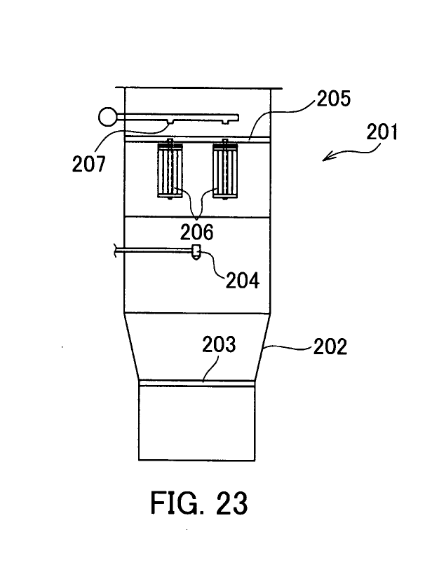

A support 191 that is made of synthetic resin may be arranged at the lower end of each of the filter guides 183 as shown in FIG. 22. When such supports are used, the base plates 182 are not provided with upper level sections 182b. In other words, the supports 191 are placed directly on the respective base plates 182. Each of the supports 191 is rigidly secured to the lower end of the corresponding filter guide 183, which is rotatably supported by the support 191 on the base plate 182. With this arrangement, it is possible to avoid the problem that each of the filter guides 183 and the corresponding upper level section 182b of the base plate, both of which are made of stainless steel, directly contact each other and become worn. A spacer made of synthetic resin may be arranged between each of the filter guides 183 and the corresponding upper level section 182b in the arrangement of FIG. 21.

The present invention is by no means limited to the above-described embodiments, which may be modified in various different ways without departing from the scope of the present invention.

For example, while the above-described embodiments are designed as fluidized bed apparatus for executing a coating process on particulates, the present invention can also be applied to apparatus for granulating particulates and apparatus for drying particulates. While embodiments comprising ultrasonic washers 55 and those comprising bubbling washers 61 are described above, it is possible to embody the present invention by using both one or more than one ultrasonic washers and one or more than one bubbling washers. In other words, it is possible, for example, to wash one or more than one filters 7 by ultrasonic oscillations of one or more than one ultrasonic washers 55, while driving the one or more than one filters 7 by one or more than one bubble flows produced by one or more than one bubbling washers 61. Furthermore, washers that can be used for the purpose of the present invention are not limited to ultrasonic washers and bubbling washers and include, for instance, in-tank agitation nozzles adapted to strongly inject washing liquid that does not contain any bubbles.

While the ceiling plate 6 is driven to move up and down and the perforated plate 9 is driven to rotate by means of a motor in the above-described embodiments, various other drive means such as actuators comprising a pneumatic cylinder may also be used for the purpose of the present invention. While the filters 7 are moved up and down by means of filter-containing type air cylinders in Embodiment 2, means for moving the filters up and down are not limited to air cylinders and include arrangements for moving up and down filters 7 suspended from the ceiling of the processing vessel 1 by means of a lifting gear arranged at the ceiling section, arrangements for moving up and down filters 7 by means of a winch arranged outside the processing vessel 1 and other arrangements. The perforated plate 9 may be driven to rotate by means of a handle and the like externally fitted to it by hand.

Filters 7 that can be used in a fluidized bed apparatus are not limited to those having a cylindrical profile as described above and include those having a polygonal profile and those having a prism-like profile. Materials that can be used for filters include unwoven fabrics of polyester and polyamide and stainless steel.

Means for driving one or more than one filters 7 up and down in an apparatus according to the invention include arrangements for moving filters up and down with a ceiling plate 6 as described above and also arrangement for moving only filters up and down. Filters may be suspended by a wire so as to be moved up and down or fitted to a support rod and the support rod may be driven to move up and down by means of an actuator such as an air cylinder.

In any of the above-described fluidized bed apparatus, it is possible to execute a washing process by means of the washers 55, while driving the ceiling plate 6 to move up and down, in order to improve the washing effect. One or more than one additional washing nozzles may be arranged to inject washing liquid and wash the inner wall of the fluidization chamber 24.

While support roller units 112 and 121, each comprising three rollers 114 and 123 are used in the washing apparatus 101 and 170 of Embodiment 3 and 6, the number of rollers 114, 123 that each support roller unit comprises is not limited to three so long as it is not less than two, although each support roller unit preferably comprises three or more than three rollers 114, 123 from the viewpoint of stably supporting the corresponding filter 103. Thus, it is particularly preferable that each support roller unit comprises three rollers 114, 123 from the viewpoint of cost and supporting effect.

It is also possible to use nozzles similar to those of the nozzles 136 of Embodiment 3 for the washers 150, 156 of Embodiment 4. While a rotary washing process using the nozzles 145 and an ultrasonic washing process using washers 151 are executed simultaneously in the above description of Embodiment 4, they may alternatively be executed independently.

The configuration of the apparatus can become complex when the liquid generation nozzles 145 or the bubbling jet nozzles 136 are arranged at the wall surface 102a of the processing vessel and driven to move up and down. Therefore, a plurality of nozzles 145 or 136 may be arranged vertically. Then, it is not necessary to move the nozzles up and down for washing the filters 103 entirely. It is also possible to arrange a plurality of nozzles 136 vertically in Embodiment 3.

While a pump 139 is arranged outside the filter washing apparatus in each of above-described Embodiments 3 through 7, a liquid feed pump may be arranged in the processing vessel 102. Then, it is possible to downsize the filter washing system to make the apparatus space saving.

1. A fluidized bed apparatus comprising:
a processing vessel having a cylindrical profile;
a filter member arranged in the processing vessel so as to be immersed in washing liquid to be injected and retained in the processing vessel; and
a washer fitted to the lateral wall of the processing vessel so as to be capable of washing the filter member immersed in the washing liquid.

2. The fluidized bed apparatus according to claim 1, wherein
the washer is an ultrasonic washer for applying an ultrasonic oscillation to the washing liquid.

3. The fluidized bed apparatus according to claim 1, wherein
the washer is a bubbling washer for supplying a bubble flow or liquid containing bubbles to the washing liquid.

4. The fluidized bed apparatus according to claim 3, wherein
the filter is rotatably arranged in the processing vessel so as to be driven to rotate in the washing liquid by the bubble flow or the liquid containing bubbles.

5. The fluidized bed apparatus according to claim 1, wherein
the filter is vertically movably arranged in the processing vessel.

6. The fluidized bed apparatus according to claim 1, wherein
the processing vessel includes a filter casing in which the filter is arranged, a spray casing in which a spray nozzle for spraying liquid to an object of processing is arranged, a material container containing the object of processing and a gas feed unit for feeding processing gas to the material container and the washer is arranged at the lateral wall of the spray casing.

7. The fluidized bed apparatus according to claim 1, further comprising:
a perforated plate arranged in the processing vessel so as to be displaceable between a first position where it is disposed substantially horizontally and a second position where it is inclined by a predetermined angle relative to the first position.

8. A filter washing method in a fluidized bed apparatus including a processing vessel having a cylindrical profile and a filter member arranged in the processing vessel, the method comprising:
injecting washing liquid into the processing vessel;
immersing the filter member in the washing liquid retained in the processing vessel; and
washing the filter member immersed in the washing liquid by means of a washer fitted to the lateral wall of the processing vessel.

9. The filter washing method according to claim 8, wherein
the washer applies an ultrasonic oscillation to the washing liquid to wash the filter member.

10. The filter washing method according to claim 8, wherein
the washer applies a bubble flow to the washing liquid to wash the filter member.

11. The filter washing method according to claim 10, wherein
the filter is driven to rotate in the washing liquid by the bubble flow.

12. The filter washing method according to claim 8, wherein
the filter member is arranged so as to be vertically movable in the processing vessel and moved to a downward position in the processing vessel while washing liquid is injected into and retained in the processing vessel so as to be immersed in the washing liquid.

13. The filter washing method according to claim 8, wherein
a perforated plate is arranged in the processing vessel of the fluidized bed apparatus so as to be displaceable between a first position where it is disposed substantially horizontally and a second position where it is inclined by a predetermined angle relative to the first position and the filter member is washed when the perforated plate is displaced to the second position.

14. A filter washing apparatus comprising:
a processing vessel formed so as to be able to retain washing liquid and rotatably contain a filter to be used in a particulate processing apparatus in a state where washing liquid is injected and retained; and
a nozzle device fitted to the processing vessel and adapted to inject a bubble flow or liquid containing bubbles to the filter immersed in the washing liquid in order to drive the filter to rotate in the washing liquid and wash the filter.

15. A filter washing apparatus comprising:
a processing vessel formed so as to be able to retain washing liquid and rotatably contain a filter to be used in a particulate processing apparatus in a state where washing liquid is injected and retained; and
a nozzle device fitted to the processing vessel and adapted to inject a liquid flow to the filter immersed in the washing liquid in order to drive the filter to rotate in the washing liquid and wash the filter.

16. The filter washing apparatus according to claim 14, wherein
the processing vessel further includes an ultrasonic washer for applying an ultrasonic oscillation to the filter immersed in the washing liquid and washing the filter in the washing liquid.

17. The filter washing apparatus according to claim 14, wherein
the processing vessel further includes:
a first retainer inserted into and rigidly anchored to the filter;
a second retainer connected to the first retainer by way of a rotary joint to make the first retainer rotatable and rotatably suspending the filter in the processing vessel; and
a support roller unit fitted to the first retainer so as to be arranged in the inside of the filter and equipped with rollers adapted to contact the inner peripheral surface of the filter.

18. The filter washing apparatus according to claim 14, wherein
the processing vessel further includes:
a column arranged on the bottom section of the processing vessel;
a filter guide rotatably mounted to the column and adapted to be inserted into the filter; and
guide pieces arranged on the outer peripheral section of the filter guide so as to contact the inner peripheral surface of the filter when inserted into the filter with the filter guide.

19. A filter washing method of washing a filter to be used in a particulate processing apparatus by containing the filter in a processing vessel storing washing liquid, the method comprising:
rotatably arranging the filter in processing vessel; and
injecting a bubble flow or liquid containing bubbles from a nozzle device arranged in the processing vessel to the filter along a tangential direction and washing the filter, driving the filter to rotate by means of the bubble flow or the liquid containing bubbles.

20. A filter washing method of washing a filter to be used in a particulate processing apparatus by containing the filter in a processing vessel storing washing liquid, the method comprising:
rotatably arranging the filter in processing vessel; and
injecting a washing liquid from a nozzle device arranged in the processing vessel to the filter along a tangential direction and washing the filter, driving the filter to rotate by means of the washing liquid.

21. The filter washing method according to claim 19, wherein
an ultrasonic oscillation is applied to the filter immersed in the washing liquid to wash the filter by means of the ultrasonic wave.

22. The filter washing apparatus according to claim 15, wherein
the processing vessel further includes an ultrasonic washer for applying an ultrasonic oscillation to the filter immersed in the washing liquid and washing the filter in the washing liquid.

23. The filter washing apparatus according to claim 15, wherein
the processing vessel further includes:
a first retainer inserted into and rigidly anchored to the filter;
a second retainer connected to the first retainer by way of a rotary joint to make the first retainer rotatable and rotatably suspending the filter in the processing vessel; and
a support roller unit fitted to the first retainer so as to be arranged in the inside of the filter and equipped with rollers adapted to contact the inner peripheral surface of the filter.

24. The filter washing apparatus according to claim 15, wherein
the processing vessel further includes:
a column arranged on the bottom section of the processing vessel;
a filter guide rotatably mounted to the column and adapted to be inserted into the filter; and
guide pieces arranged on the outer peripheral section of the filter guide so as to contact the inner peripheral surface of the filter when inserted into the filter with the filter guide.

25. The filter washing method according to claim 20, wherein
an ultrasonic oscillation is applied to the filter immersed in the washing liquid to wash the filter by means of the ultrasonic wave.
